(19) United States
(12) Patent Application Publication
(10) Pub. No.: US 2024/0218526 A1
(43) Pub. Date: Jul. 4, 2024

(54) Systems for Direct Generation of High-Pressure Hydrogen Gas and Methods Thereof

(71) Applicants: California Institute of Technology, Pasadena, CA (US); Battelle Memorial Institute, Richland, WA (US)

(72) Inventors: Harry A. Atwater, South Pasadena, CA (US); Chengxiang Xiang, San Marino, CA (US); Zhiyuan Qi, Pasadena, CA (US); Monica Hwang, Torrance, CA (US); Richard F. Zheng, Lake Oswego, OR (US); Wei Wang, Richland, WA (US); Soowhan Kim, Richland, WA (US); Ryan Benavides, Pasadena, CA (US); Daniel R. Bottenus, Richland, WA (US)

(73) Assignees: California Institute of Technology, Pasadena, CA (US); Battelle Memorial Institute, Richland, WA (US)

(21) Appl. No.: 18/542,516

(22) Filed: Dec. 15, 2023

Related U.S. Application Data
(60) Provisional application No. 63/536,623, filed on Sep. 5, 2023.
(60) Provisional application No. 63/432,947, filed on Dec. 15, 2022.

(51) Int. Cl. C25B 1/04; C25B 9/15; C25B 9/23; C25B 11/032; C25B 11/052; C25B 11/063; C25B 11/065; C25B 11/075; C25B 11/081; C25B 11/085; C25B 15/08

(52) U.S. Cl. CPC C25B 1/04; C25B 9/15; C25B 9/23; C25B 11/032; C25B 11/052; C25B 11/063; C25B 11/065; C25B 11/075; C25B 11/081; C25B 11/085; C25B 15/08

(57) ABSTRACT

Systems and methods for generating high-pressure hydrogen are described. The hydrogen generation systems include hybrid electrolyzer systems and catalytic compression systems. The systems can directly generate gaseous hydrogen at a pressure of at least 700 bar.

### CROSS-REFERENCE TO RELATED APPLICATIONS

The current application claims the benefit of and priority under 35 U.S.C. § 119 (e) to U.S. Provisional Patent Application No. 63/432,947 entitled “Redox Reaction Based, Catalytic Generation and Compression of Hydrogen Using Water and Electricity” filed Dec. 15, 2022, and to U.S. Provisional Patent Application No. 63/536,623 entitled “Redox Reaction Based, Catalytic Generation and Compression of Hydrogen Using Water and Electricity” filed Sep. 5, 2023. The disclosures of U.S. Provisional Patent Application Nos. 63/432,947 and 63/536,623 are hereby incorporated by reference in their entirety for all purposes.

### GOVERNMENT SPONSORED RESEARCH

This invention was made with Government support under Grant No. DE-AR0001563 and Contract DE-AC0576RL01830 awarded by the U.S. Department of Energy. The Government has certain rights in the invention.

### FIELD OF THE INVENTION

The present invention generally relates to systems and methods for direct generation of high-pressure hydrogen gas; and more particularly to systems and methods for direct generation of high-pressure hydrogen gas using hybrid electrolysis stacks and catalytic compression reactors.

### BACKGROUND OF THE INVENTION

Hydrogen gas (H₂) is becoming an important alternative energy source in multiple industrial sectors. However, hydrogen gas has a low volumetric energy density of about 0.01079 MJ/L at standard temperature and pressure, which is significantly lower compared to the commonly used fuels for example gasoline of about 34 MJ/L. Storage of gaseous hydrogen at high pressures in tanks is a common approach in both stationary and mobile transportation applications and for hydrogen refueling for fuel cell vehicles. Gaseous hydrogen at high pressures is also heavily used in the Haber process for ammonia production and hydro-cracking of heavy petroleum. Low-cost high-pressure hydrogen may play an important role in the future grid configurations for long-duration storage needed for deep decarbonization and improved resilience. Current compression technologies for high pressure gaseous hydrogen generation can be costly and unreliable. Low cost and reliable hydrogen compression processes may be needed for generating high-pressure hydrogen gas.

### BRIEF SUMMARY OF THE INVENTION

Many embodiments are directed to systems for generating high-pressure gaseous hydrogen and associated methods thereof.

Some embodiments include a gaseous hydrogen generation system comprising:
an electrochemical cell comprising: a cathode that reduces a redox couple in an electrolyte, wherein the reduction reaction is not a hydrogen evolution reaction; and an anode that oxidizes an oxygen evolution reaction to generate a plurality of protons in the electrolyte; and
a reactor to receive the protonated electrolyte, wherein the reactor comprises a catalyst to catalyze a reaction that oxidizes the reduced redox couple and reduces the plurality of protons to a gaseous hydrogen, and generate a discharged electrolyte; and
a pressurized container to receive the discharged electrolyte and the gaseous hydrogen, wherein the gaseous hydrogen separates from the discharged electrolyte such that a pressurized gaseous hydrogen is collected and the discharged electrolyte flows to the electrochemical cell;
   wherein the pressurized gaseous hydrogen has a pressure of at least 700 bar.

Some embodiments further comprise a transfer cylinder with a moveable piston separating the transfer cylinder into a first chamber and a second chamber; wherein the second chamber receives the protonated electrolyte from the electrochemical cell; wherein a pump pressurizes an aqueous solution in the first chamber to move the piston towards the second chamber and pressurize the protonated electrolyte into the reactor, such that the pump is not in physical contact with the protonated electrolyte.

In some embodiments, the electrochemical cell has a configuration of a flow cell, a flow stack, or a flow assembly.

In some embodiments, the redox couple dissolves in an aqueous solution and is selected from the group consisting of: a vanadium redox couple (V³⁺/V²⁺), a quinone based redox couple, a phenazine-based derivative (DHPS (7,8-dihydroxyphenazine-2-sulfonic acid), DHPS/H₂-DHPS), a chromium redox couples (Cr³⁺/Cr²⁺), and an iron redox couple (Fe³⁺/Fe²⁺).

In some embodiments, the catalyst comprises an active catalyst material and a support material with a porous structure.

In some embodiments, the active catalyst material comprises molybdenum carbide, and the support material comprises alumina beads.

Some embodiments further comprise a container to store the protonated electrolyte for an extended period of time.

In some embodiments, the cathode comprises a material selected from the group consisting of: a carbon felt, a carbon cloth, a graphite felt, and a carbon felt coated with a gas diffusion layer.

In some embodiments, the anode comprises an iridium oxide coated titanium gas diffusion electrode.

Some embodiments further comprise an ion exchange membrane between the cathode and the anode, wherein the ion exchange membrane comprises a material selected from the group consisting of: Nafion®, Nafion® 212, Nafion® 211, and a Nafion@ ionomer.

In some embodiments, the electrochemical cell is configured to achieve a current density greater than or equal to 200 mA/cm².

In some embodiments, the electrochemical cell is configured to operate at a voltage less than or equal to 2 V.

In some embodiments, the protonated electrolyte has a pH less than or equal to 2.

In some embodiments, the reactor comprises a material selected from the group consisting of: a nickel-chrome based alloy, a nickel-iron-chrome based alloys, an Inconel® alloy, Inconel® 625, an Incoloy® alloy, Incoloy® 20, a Hastelloy® alloy, and Hastelloy® C-276.

In some embodiments, the pressurized container is a gas liquid separator.

In some embodiments, the system is a batch reactor or a continuous reactor.

Some embodiments include a method for generating gaseous hydrogen, comprising:
producing a protonated electrolyte in an electrochemical cell, wherein the electrochemical cell comprises: a cathode that reduces a redox couple in an electrolyte, wherein the reduction reaction is not a hydrogen evolution reaction; and an anode that oxidizes an oxygen evolution reaction to generate a plurality of protons to produce the protonated electrolyte;
contacting the protonated electrolyte with a catalyst in a reactor, wherein the catalyst catalyzes a reaction that oxidizes the reduced redox couple and reduces the plurality of protons to a gaseous hydrogen, and generate a discharged electrolyte; and
collecting a pressurized gaseous hydrogen by adding the discharged electrolyte and the gaseous hydrogen to a pressurized container, wherein the gaseous hydrogen separates from the discharged electrolyte such that the pressurized gaseous hydrogen is collected and the discharged electrolyte flows to the electrochemical cell;
   wherein the pressurized gaseous hydrogen has a pressure of at least 700 bar.

Some embodiments further comprise pumping the protonated electrolyte into the reactor via a transfer cylinder, wherein the transfer cylinder comprises a moveable piston separating the transfer cylinder into a first chamber and a second chamber; wherein the second chamber receives the protonated electrolyte from the electrochemical cell; wherein a pump pressurizes an aqueous solution in the first chamber to move the piston towards the second chamber and pressurize the protonated electrolyte into the reactor, such that the pump is not in physical contact with the protonated electrolyte.

In some embodiments, the electrochemical cell has a configuration of a flow cell, a flow stack, or a flow assembly.

In some embodiments, the redox couple dissolves in an aqueous solution and is selected from the group consisting of: a vanadium redox couple (V³⁺/V²⁺), a quinone based redox couple, a phenazine-based derivative (DHPS (7,8-dihydroxyphenazine-2-sulfonic acid), DHPS/H₂-DHPS), a chromium redox couples (Cr³⁺/Cr²⁺), and an iron redox couple (Fe³⁺/Fe²⁺).

In some embodiments, the catalyst comprises an active catalyst material and a support material with a porous structure.

In some embodiments, the active catalyst material comprises molybdenum carbide, and the support material comprises alumina beads.

Some embodiments further comprise storing the protonated electrolyte in a container for an extended period of time.

In some embodiments, the cathode comprises a material selected from the group consisting of: a carbon felt, a carbon cloth, a graphite felt, and a carbon felt coated with a gas diffusion layer.

In some embodiments, the anode comprises an iridium oxide coated titanium gas diffusion electrode.

In some embodiments, the electrochemical cell further comprises an ion exchange membrane between the cathode and the anode, wherein the ion exchange membrane comprises a material selected from the group consisting of: Nafion®, Nafion® 212, Nafion® 211, and a Nation® ionomer.

In some embodiments, the electrochemical cell is configured to achieve a current density greater than or equal to 200 mA/cm².

In some embodiments, the electrochemical cell is configured to operate at a voltage less than or equal to 2 V.

In some embodiments, the protonated electrolyte has a pH less than or equal to 2.

In some embodiments, the reactor comprises a material selected from the group consisting of: a nickel-chrome based alloy, a nickel-iron-chrome based alloys, an Inconel® alloy, Inconel® 625, an Incoloy® alloy, Incoloy® 20, a Hastelloy® alloy, and Hastelloy® C-276.

In some embodiments, the electrochemical cell has a configuration of a flow cell, a flow stack, or a flow assembly; wherein the pressurized container is a gas liquid separator.

In some embodiments, the redox couple dissolves in an aqueous solution and is selected from the group consisting of: a vanadium redox couple (V³⁺/V²⁺), a quinone based redox couple, a phenazine-based derivative (DHPS (7,8-dihydroxyphenazine-2-sulfonic acid), DHPS/H₂-DHPS), a chromium redox couples (Cr³⁺/Cr²⁺), and an iron redox couple (Fe³⁺/Fe²⁺); wherein the catalyst comprises an active catalyst material and a support material with a porous structure; wherein the reactor comprises a material selected from the group consisting of: a nickel-chrome based alloy, a nickel-iron-chrome based alloys, an Inconel® alloy, Inconel® 625, an Incoloy® alloy, Incoloy® 20, a Hastelloy® alloy, and Hastelloy® C-276; wherein the cathode comprises a material selected from the group consisting of: a carbon felt, a carbon cloth, a graphite felt, and a carbon felt coated with a gas diffusion layer; wherein the anode comprises an iridium oxide coated titanium gas diffusion electrode

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1A illustrates a mechanical compression process in accordance with prior art.

FIG. 1B illustrates an electrochemical compression process in accordance with prior art.

FIG. 2 illustrates a schematic of high-pressure hydrogen generation system in accordance with an embodiment.

FIG. 3 illustrates a schematic of high-pressure hydrogen generation system using vanadium redox couple in accordance with an embodiment.

FIGS. 4A and 4B illustrate a 10 cm² hybrid flow cell and its charging voltage behaviors with different current densities and flow rates at room temperature respectively in accordance with an embodiment.

FIG. 5 illustrates displaced volume measured in the vanadium reservoir during the charging and equivalent time with and without current in accordance with an embodiment.

FIG. 6A illustrates charging voltage profile at 1 A cm² and ambient temperature with different compositions of anolytes and catholytes in accordance with an embodiment.

FIG. 6B illustrates electrolyte mass changes after charging in accordance with an embodiment.

FIG. 7 illustrates cell voltage at various temperatures, flow rates, and current densities in accordance with an embodiment.

FIG. 8A illustrates stability of charging voltage profiles of a 10 cm² V-O2 flow cell in accordance with an embodiment.

FIG. 8B illustrates the mid-point voltages to evaluate the degradation in accordance with an embodiment.

FIG. 9 illustrates a synthesis schematic of the catalyst in accordance with an embodiment.

FIGS. 10A and 10B illustrate X-ray diffraction (XRD) patterns of Al₂O₃ supported MoₓC_{y} catalysts annealed in air and nitrogen respectively in accordance with an embodiment.

FIGS. 11A and 11B illustrate powder X-ray diffraction (p-XRD) patterns of ex-situ and in-situ carburized catalysts in accordance with an embodiment.

FIG. 12 illustrates nitrogen isotherm of Al₂O₃ support and MoₓC_{y}/Al₂O₃ catalysts in accordance with an embodiment.

FIG. 13 illustrates a schematic of the designed reactor for rate measurement in accordance with an embodiment.

FIG. 14 illustrates initial rate measurement with different catalysts in accordance with an embodiment.

FIG. 15A illustrates hydrogen yield in bar and conversion (%) over time in accordance with an embodiment.

FIG. 15B illustrates calculated In [V²⁺] fitted with time in accordance with an embodiment.

FIG. 16 illustrates hydrogen yield in bar using as-synthesized Mo₂C/Al₂O₃ and commercial Pt/Al₂O₃ with and without stirring in accordance with an embodiment.

FIG. 17A illustrates calculated reaction potentials versus reaction conversions at different starting H₂ pressure in accordance with an embodiment.

FIG. 17B illustrates hydrogen yields of commercial Pt/Al₂O₃ using 100% and 30% V²⁺ solutions in accordance with an embodiment.

FIG. 18 illustrates X-ray diffraction (XRD) patterns of the catalysts before and after reaction in accordance with an embodiment.

FIG. 19 illustrates pressure and V³⁺/V²⁺ ratio versus time in accordance with an embodiment.

FIG. 20 illustrates a process flow diagram in accordance with an embodiment.

FIG. 21 illustrates a continuous 700-bar plug flow reactor to produce hydrogen in accordance with an embodiment.

FIG. 22 illustrates a continuous design of a 350 bar plug flow reactor to produce hydrogen in accordance with an embodiment.

### DETAILED DESCRIPTION OF THE INVENTION

In this disclosure, hydrogen, H₂, and hydrogen gas are used interchangeably, and refer to gaseous hydrogen, unless specified otherwise.

In this disclosure, high-pressure hydrogen refers to gaseous hydrogen with a pressure greater than or equal to about 700 bar; low-pressure hydrogen refers to gaseous hydrogen with a pressure less than or equal to about 30 bar, unless specified otherwise.

In this disclosure, room temperature refers to temperatures ranging from about 20° ° C.to about 25° C., unless specified otherwise.

Electrolysis is a common technique that uses electricity to split water to produce gaseous hydrogen. The electrolysis reaction takes place in a unit such as an electrolyzer. Electrolyzers can include an anode and a cathode separated by an electrolyte and a polymer electrolyte membrane (PEM). Water oxidized at the anode to form oxygen and positively charged hydrogen ions (protons). The water oxidation reaction at the anode: 2H₂O (aq)→O₂ (gas)+4H⁺(aq)+4e⁻, is also known as the oxygen evolution reaction (OER). The electrons flow through an external circuit and the hydrogen ions selectively move across the PEM to the cathode. At the cathode, hydrogen ions combine with electrons from the external circuit to form hydrogen gas. The reduction reaction at the cathode: 2H⁺(aq)+2e⁻→H₂ (gas), is also known as the hydrogen evolution reaction (HER). The PEM electrolysis system can generate gaseous hydrogen at about 30-bar.

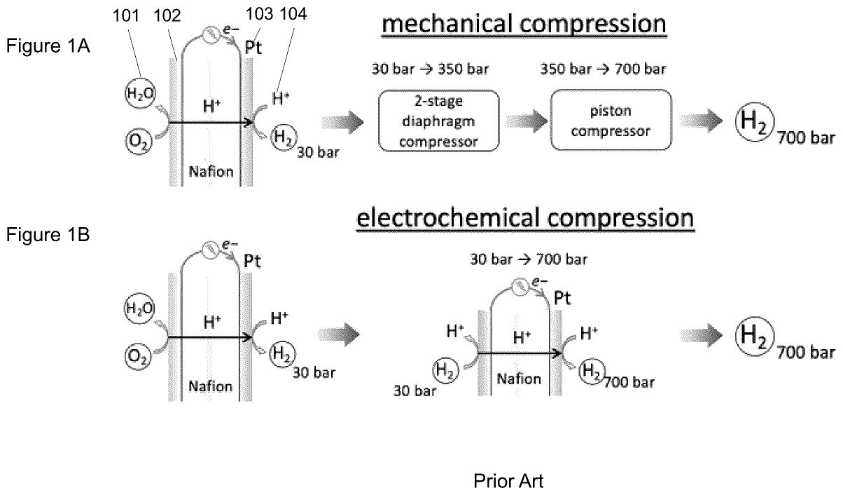

The generated gaseous hydrogen can then go through a compression process to bring up the pressure from about 30-bar to about 700-bar. Conventional compression processes include mechanical compression processes or electrochemical compression processes. The mechanical compression processes use a multi-stage compressor where a motor drives a piston and/or a diaphragm back and forth. The motion compresses the hydrogen by reducing the volume it occupies. FIG. 1A illustrates a mechanical compression process. A PEM electrolysis system can be used to generate gaseous hydrogen at a pressure of about 30-bar. The OER reactions 101 at the anode 102 generate protons. The protons are reduced at the cathode 103 via HER reactions 104 to form low pressure hydrogen. The gaseous hydrogen is then being compressed via a 2-stage diaphragm compressor to bring the pressure to about 350-bar. A second piston compressor can be used to continue to compress the hydrogen to reach about 700-bar.

The electrochemical compression process uses a multi-stage electrochemical hydrogen compressor incorporates membrane-electrode-assemblies separated by proton exchange membranes in series to reach higher pressures. FIG. 1B illustrates an electrochemical compression process. The lower pressure hydrogen (about 30-bar) is supplied at the anode for oxidation. When a current is passed through the electrodes, protons and electrons are generated at the anode. The protons are electrochemically driven across the proton exchange membrane to the cathode, after which the protons combine with the rerouted electrons to form hydrogen into a highly pressurized container to form hydrogen at about 700-bar.

The mechanical compression and electrochemical compression processes for high pressure gaseous hydrogen generation can be expensive and unreliable. The cost of hydrogen compression alone from 30-bar to 700-bar is estimated to be $1.54/kg via multi-stage mechanical compressors. While reciprocating/mechanical compressors are commonly used for hydrogen compression, the presence of multiple moving parts, embrittlement of piston, manufacturing complexity and difficulty in managing thermal transfer and maintenance increase the cost of the hydrogen compression. In addition, mechanical compressors often present vibrations and noises. Reliable, effective, and cheaper processes to generate high pressure hydrogen are needed for hydrogen storage and transport.

Many embodiments achieve direct generation of high-pressure hydrogen (pressure greater than or equal to about 700-bar) using hybrid electrochemical systems (also referred as hybrid electrolysis stacks or hybrid electrolysis stack units or hybrid electrolyzer systems) and catalytic compression systems (also referred as catalytic reactors or catalytic chambers). In several embodiments, the hybrid electrochemical systems undergo a charging process and generate and store protons in electrolytes. The acidified electrolytes undergo a catalytic discharging process in the catalytic compression systems to directly generate high-pressure hydrogen. In various embodiments, the produced gaseous hydrogen can be compressed directly from about 1 bar to at least 700-bar in a catalytic reactor without energy inputs (such as in mechanical compression) or without the high capital expenditure requirements of electrolysis-like stacks (such as in electrochemical compression). Several embodiments can directly generate gaseous hydrogen from about 5-bar to about 1000-bar.

In many embodiments, the hybrid electrochemical systems include a plurality of electrochemical cells. The plurality of electrochemical cells can form a stack; or an assembly; or a flow cell; or a flow stack; or a fuel cell configuration. Each of the plurality of the electrochemical cells includes at least a cathode, a catholyte, an anode, an anolyte, and an ion exchange membrane. At the cathode, a reduction reaction of a redox couple forms a reduced form of the redox couple and store it in the catholyte. At the anode, oxidation reactions (OERs) of water forms oxygen, protons, and electrons. The protons produced at the anode are transported to the catholyte through the ion exchange membrane and are temporarily stored in the catholyte, which also causes a decrease of the catholyte pH during the charging process.

In conventional PEM electrolysis systems, protons stored in the catholyte are reduced to generate hydrogen at the cathode directly. The generated hydrogen via conventional PEM electrolysis systems have a pressure of about 30-bar. In many embodiments, the hybrid electrochemical systems use a redox couple at the cathode instead of directly producing gaseous hydrogen at the cathode. During the charging process in the hybrid electrochemical systems, the redox couple is used as the energy carrier for the proton that can be reduced in the catalytic discharging process to generate high-pressure hydrogen.

Redox couples for the hybrid electrochemical systems in accordance with many embodiments are soluble in aqueous solutions and/or electrolytes. The redox couples can store more energy in a given volume. The electrochemical potential of the redox couple should be higher than the hydrogen reduction reaction such that protons generated from water oxidation reactions can be stored in the catholyte and not be reduced via the HERs (2H⁺(aq)+2e⁻→H₂ (gas)). In several embodiments, the redox couple is reduced at the cathode. The reduced redox couple species and protons are stored in the catholyte for subsequent processes. Examples of redox couples include (but are not limited to) vanadium redox couples (V³⁺/V²⁺), quinone based redox couples, phenazine-based derivatives (DHPS (7,8-dihydroxyphenazine-2-sulfonic acid), DHPS/H₂-DHPS), chromium redox couples (Cr³⁺/Cr²⁺), and iron redox couples (Fe³⁺/Fe²⁺).

Several embodiments implement catalytic compression reactors for hydrogen generation and compression at about 700-bar. In some embodiments, compatible catalyst materials and catalysts suitable for multiple cycle reactions can be selected for the reactor. The catalyst placement, head space volume, flow rate of the charged electrolyte, and the spatially and temporally resolved discharge rate of the vanadium redox couples and hydrogen generation rate can be systematically modeled and simulated by a multi-physics model that accounts for important chemical reactions and fluid transports.

In certain embodiments, suitable catalytic compression reactor designs and compatible reactor materials that enable chemical stability of the hydrogen generation can be selected. Compatible reactor materials that can accommodate high pressure hydrogen generation and at the same time are chemically compatible with the presence of vanadium redox couples and highly acidic electrolytes can be used. Multi-physics modeling and simulation can be used to design and optimize the reactor dimensions and operating points. Some embodiments investigate heat transfer and the temperature change during the catalytic discharging process in the adiabatic reactor and its impact on the resulting pressure using multi-physics modeling.

Some embodiments perform the catalytic compression at from about 350-bar to about 700-bar in a batch mode. In batch mode, the charged vanadium electrolyte can be introduced in the catalytic compression reactor before applying a hydrogen back pressure of about 350-bar at the headspace of the reactor. The catalyst (such as molybdenum carbide impregnated alumina beads) can be introduced and the change of the pressure as a function of time can be recorded and used to analyze the rate of discharge and hydrogen generation at about 350-bar.

Several embodiments integrate a hybrid electrochemical cell and a catalytic compression reactor and operate the system at different conditions. Some embodiments operate the charging step at different operating temperatures. A high depth of charging is important to achieve efficient and high pressure (>700-bar) discharge in the subsequent discharge step. Cell voltages, electrolyte flow rates and crossover rates in the hybrid electrochemical cell can be optimized corresponding to the depths of charging to flux match with the catalytic compression cell in the flow configuration. In addition, various safety precautions can be carried out to avoid hydrogen leaks and sudden discharges.

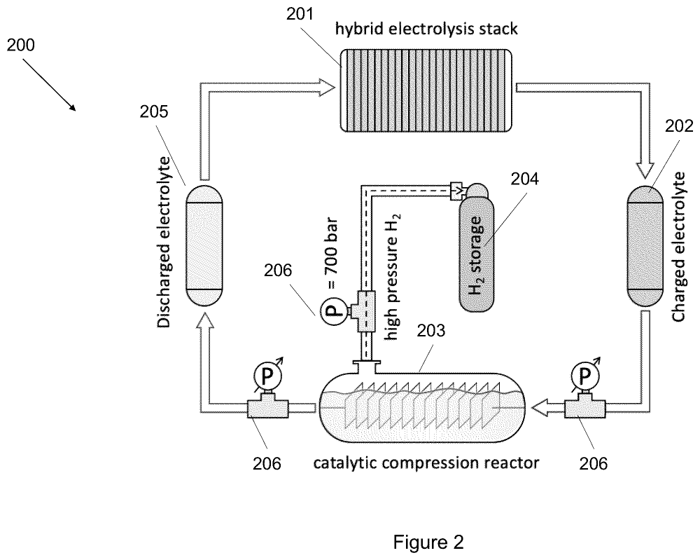

FIG. 2 illustrates a schematic of high-pressure hydrogen generation system in accordance with an embodiment. The system 200 includes hybrid electrolysis stacks 201, containers for charged electrolyte 202, catalytic compression reactors 203, high-pressure hydrogen storage container 204, containers 205 for discharged electrolyte, and various control valves 206 to direct fluid flow. The hybrid electrolysis stacks 201 comprises a plurality of electrochemical cells. For each electrochemical cell, the cathode reduces a redox couple to a reduced form, and the anode oxidizes water to gaseous oxygen and protons. The reduced redox couple and the protons can be transported and stored in the containers for charged electrolyte 202. The storage can be an extended time period so the generation of hydrogen gas can be on demand. The charged electrolyte can be flown into a catalytic compression reactor 203 via a control valve 206. The control valve 206 should be compatible with acidic solutions. The catalytic compression reactor 203 includes high surface area catalyst to catalyze the reaction that reduces protons to gaseous hydrogen and oxidizes the redox couple to the oxidized form. The catalytic compression reactor is compatible low pH (for example pH less than about 2). Once the reaction is complete, gaseous hydrogen and the discharged electrolyte can be flown to a pressurized gas/liquid separator where gaseous hydrogen can rise to the top and the liquid stays at the bottom. The high-pressure hydrogen can be stored in the hydrogen storage container 204. The discharged electrolyte containing the oxidized form of the redox couple can be collected in a container 205 and the discharged electrolyte can be used for another cycle of high-pressure hydrogen generation reaction.

Several embodiments implement vanadium redox couples in the hybrid electrolysis systems. In the hybrid electrolysis stack, vanadium redox couples in the catholyte are reduced at the cathode from V³⁺ to V²⁺ as shown in Reaction (1), while water is oxidized at the anode into O₂ as shown in Reaction (2). The protons produced at the anode are transported to the catholyte and temporarily stored in the catholyte, which also causes a decrease of the catholyte pH during the charging process. In contrast to the conventional PEM electrolysis system, the hybrid electrolysis stack uses a vanadium redox couple at the cathode instead of directly producing H₂ at 30-bar at the cathode. During the electrochemical charging process in the hybrid electrolysis stack, the vanadium redox couple is used as the energy carrier for the high pressure (700 bar) hydrogen that can be produced in the subsequent step.

$$\begin{matrix}{V}^{3 +} + {e}^{-} \to {V}^{2 +} & ( {E°}^{′}\end{matrix} = - 499 mV vs . SCE ) \qquad ( 1 )$$

$$\begin{matrix}2 {H}_{2} O \to {O}_{2} + 4 {H}^{+} + 4 {e}^{-} & ( E° = 986 mV vs . SCE )\end{matrix} \qquad ( 2 )$$

$$\begin{matrix}2 H ++ 2 e - \to {H}_{2} & ( E° = - 244 mV vs . SCE )\end{matrix} \qquad ( 3 )$$

$$2 {H}^{+} + 2 {V}^{2 +} {⟶}^{{Mo}_{2} C} {H}_{2} + 2 {V}^{3 +} \qquad ( 4 )$$

In many embodiments, catalytic discharging processes are followed by the electrochemical charging processes. In the catalytic compression reactor, the charged catholyte (V²⁺) is circulated to a pressurized reactor in the presence of a catalyst material, such as (but not limited to) Mo₂C. In the catalytic discharging process, the reduced V²⁺ redox species is oxidized chemically to V³⁺ while the stored H⁺ is reduced chemically into H₂ at high pressure, as shown in Reaction (4). All the electric energy consumption of the high-pressure hydrogen production systems in accordance with many embodiments occurs in the hybrid electrolysis stack, and that the subsequent catalytic compression reactor does not require any additional energy inputs. A 255 mV Nernst potential difference exists between the redox couple (V^{2+/3+}) and the hydrogen evolution reaction (Reaction 3). In several embodiments, the catalytic compression process follows a about 60 mV/dec relation in the gaseous H₂ compression. 255 mV overpotential in the V^{2+/3+} system, which is capable of producing compressed hydrogen with a pressure that exceeds 10,000 bar at the thermodynamic limit.

Conventional electrochemical compression processes use two electrochemical stacks, one for hydrogen generation at 30-bar and another for hydrogen compression to 700-bar as shown in FIG. 1B. Both electrochemical stacks require electricity as the energy inputs. In the direct high-pressure hydrogen production systems in accordance with many embodiments, only one electrochemical stack is needed to produce the charged redox couple (V^{2+/3+}) as shown in Reaction (1), the subsequent hydrogen generation and compression step uses a high-pressure reactor and does not require any energy inputs.

The direct high-pressure hydrogen generation systems can have similar energy efficiency to the electrochemical compression processes. The hybrid electrochemical systems in accordance with some embodiments may need larger cell voltage to overcome the 255 mV thermodynamic potential difference between V^{2+/3+} redox couple and HER. However, the voltage needed in the conventional electrochemical compression processes, which follows about 60 mV/dec relation to increase the H₂ pressure from 30-bar to 700-bar, and overpotentials for hydrogen oxidation reaction (HOR) and HER in the electrochemical stack for hydrogen compression is larger than the catalytic compression processes. The conventional electrochemical stack for hydrogen compression may face challenges in scaling up due to hydrogen leaks as well as high capital expenditure associated with the stack. Compared to the conventional electrochemical compression processes, the direct high-pressure hydrogen generation in accordance with various embodiments are cost effective using one electrolysis unit for the charging step and a reactor vessel with low-cost catalysts for the catalytic discharging step, eliminating a second electrolysis unit that is needed for hydrogen compression in conventional processes.

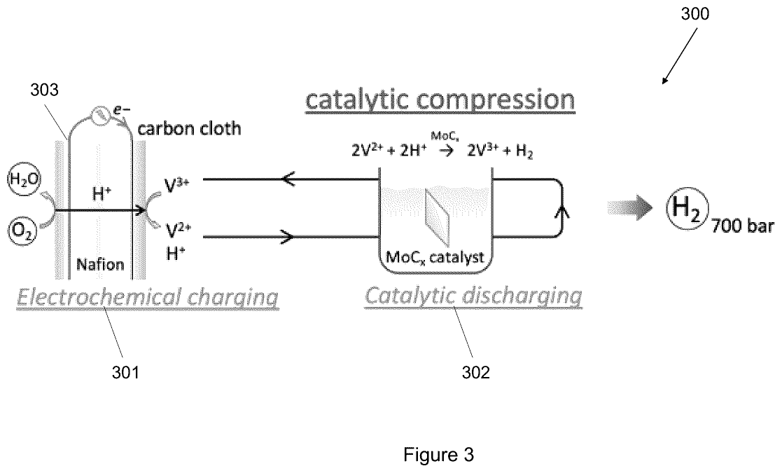

FIG. 3 illustrates a schematic of high-pressure hydrogen generation system using vanadium redox couple in accordance with an embodiment. The high-pressure hydrogen generation system 300 includes a hybrid electrolyzer system 301 and a catalytic compression system 302. During the electrochemical charging processes, in a unit cell 303 of the hybrid electrolyzer system 301, the water oxidation reaction (Reaction 2) occurs at the anode and generates protons and electrons. Protons transfer across the ion exchange membrane (such as Nafion® membranes). Electrons transport through the external circuit. The vanadium reduction reaction (Reaction 1) occurs at the cathode (such as a carbon cloth electrode) to generate V²⁺. V²⁺ and protons can be transported into the catalytic compression system 302, where a catalyst (such as MoCx catalysts) can catalyze Reaction 4. The generated hydrogen can be collected in a pressurized container or chamber to produce high-pressure hydrogen (pressure of about 700-bar). The discharged electrolyte can be reused during the electrochemical charging processes.

### Hybrid Electrolyzer System

In many embodiments, the hybrid electrolyzer systems can achieve low cost redox couple (such as V²⁺) and protons in the catholyte using renewable electrons for the subsequent hydrogen generation and compression in the catalytic compression reactors. Electrolyzers can range in size from small, appliance-size equipment that is well-suited for small-scale distributed hydrogen production to large-scale, central production facilities that could be tied directly to renewable or other non-greenhouse-gas-emitting forms of electricity production.

The hybrid electrolyzer systems include at least one cathode electrode, at least one anode electrode, at least one cathode flow plate, at least anode flow plate, at least one bipolar flow plate when the hybrid electrolyzer system has a multi-cell configuration. The electrodes and/or the flow plates can be made with various materials. Examples of electrode and flow plate materials include (but are not limited to) metals, metal alloys, nickel, nickel-based alloys, copper, copper-based alloys, titanium, titanium-based alloys, iron, iron-based alloys, stainless steel, platinum, gold, silver, carbon, carbon cloth, carbon felt, carbon paper, glassy carbon, graphite, and any combinations thereof. Electrodes can be in various configurations such as (but not limited to) porous structures, foils, films, layers, coatings, plates, and any combinations thereof. Electrodes can be of various sizes with at least one dimension ranging from about 1 mm to about 100 cm. The cathodes can include a gas diffusion layer (GDL) as part of the electrodes. Examples of the cathodes include (but are not limited to) carbon-based electrodes, such as graphite felt, carbon felt, carbon paper, and carbon cloth, ELAT® electrodes. The anodes can be gas diffusion electrodes (GDEs). Examples of the anodes include (but are not limited to) titanium GDEs, iridium oxide (IrOx) coated titanium GDEs, and ruthenium oxide (RuOx) coated titanium GDEs. In the hybrid electrolyzer with multi-cell stack, the bipolar flow plate can be integrated with electrically conductive bipolar plates and plastic frames with flow channels to control the shunt current loss. The plastic frame's materials are chemically stable and such as (but not limited) PTFE, PP, and PVC.

In various embodiments, the cathodes and anodes can be in contact with electrolytes. The electrolytes should be compatible with the redox couples used in the hybrid electrolyzer systems. The suitable electrolytes should have the desired pH, desired electrical conductivity, desired stability at various temperatures, desired solubility for active materials, and desired viscosity. The electrolytes can be aqueous solution or organic solution. For vanadium redox couples, some embodiments use vanadium sulfate and sulfuric acid as electrolytes. In many embodiments, the compositions of the electrolytes can be optimized to lower the operating voltage of the electrolyzer systems.

In many embodiments, the hybrid electrolyzer systems can use ion exchange membranes such as cation exchange membranes or anion exchange membranes between the catholytes and anolytes. The ion exchange membranes can be made of (but not limited to) polymers, fluorinated polymers, perfluorosulfonic acid (PFSA)/polytetrafluoroethylene (PTFE) copolymers, PTFE, functionalized poly(aryl piperidinium) polymer, hydrocarbon resins, and poly(aryl piperidinium) resin. Examples of cation exchange membranes include (but are not limited to) Nation®, Nafion® 212, Nafion® 211, Nafion® ionomers, Nafion® membranes, and/or any of a variety of Nation® membranes. Examples of anion exchange membranes include (but are not limited to) SELEMION®, NEOSEPTA®, fumapem FAA, fumasep FAP, Sustainion® X37, Versogen® PiperION, lonomr Aemion®, Fumasep membranes, Sustainion® membranes, Sustainion® ionomer, PiperION ionomer, and PiperION membranes. Several embodiments may modify the ion exchange membranes with ionomers ionomers such as (but not limited to) Nafion® D520 ionomer, and Versogen® PiperION-A5 ionomer. In certain embodiments, the ion exchange membranes can be pretreated in water; or in an aqueous solution; or in an organic solution; at an elevated temperature. As can readily be appreciated, any of a variety of ion exchange membranes can be utilized as appropriate to the requirements of specific applications in accordance with various embodiments of the invention.

Several embodiments implement various flow diffuser patterns in the hybrid electrolyzer systems. Examples of the flow patterns include (but are not limited to) interdigitated, serpentine, and flow-through. The flow patterns can improve mass-transport and reduce ohmic losses.

In various embodiments, current density, flow rate, electrolyte concentrations, and operating temperatures of the electrolyzers system can be optimized to minimize the crossover rate or the redox couple. Crossover is the unwanted process where a molecule of electrolyte diffuses across the membrane into the opposing electrolyte. The wandering electrolyte is quenched chemically or electrochemically if charged. Once crossed over, the electrolyte can no longer be used to store charge, which causes the capacity of the battery to fade in an unrecoverable way. This can also lead to degradation of the electrolyte solutions, as the opposing electrolytes are more likely to react and decompose when mixed together than if held separately. Redox flow batteries with high crossover rate can have the capacity fade and performance degrade drastically so as to limit the lifetime of the battery. To ensure the potential of long lifetimes and high capacities for flow batteries, crossover needs to be effectively eliminated.

In many embodiments, the electrolyzer systems can be made with materials that are compatible with the systems. The term compatibility is defined as having minimal or no deleterious electrochemical or physical reactions between any components of the cell and electrolyte solutions that would preclude long-duration and multi-year device lifetime. Examples of suitable electrolyzer materials include (but are not limited to) chemically resistant materials such as fluorinated polymers, polytetrafluroethylene (PTFE, also known as Teflon®), polyvinylidene fluoride (PVDF) or Viton®, Nafion®, Kalrez®; non-reactive minerals such as glass, graphite, and carbon felt; other resistant materials or coatings to increase chemical resistance; and chemically resistant separators such as fluorinated membranes.

In many embodiments, the hybrid electrolyzer systems can achieve current densities greater than or equal to about 50 mA/cm²; or greater than or equal to about 100 mA/cm²; or greater than or equal to about 200 mA/cm²; or greater than or equal to about 300 mA/cm²; or greater than or equal to about 500 mA/cm²; or greater than or equal to about 1000 mA/cm²; or greater than or equal to about 1500 mA/cm². The hybrid electrolyzer systems in accordance with several embodiments can be operated at voltage lower than or equal to about 5 V; or lower than or equal to about 4 V; or lower than or equal to about 3 V; or lower than or equal to about 2 V. The hybrid electrolyzer systems can maintain the performance and operate for extended periods of time such as (but not limited to) at least 1 hour; or at least 10 hours; or at least 20 hours; or at least 30 hours; or at least 40 hours; or at least 50 hours; or at least 100 hours; or at least 200 hours; or at least 300 hours; or at least 400 hours; or at least 500 hours; or at least 1000 hours. In several embodiments, the hybrid electrolyzer systems can function from about 20° C.to about 100° C.

The hybrid electrolyzer cells can be in various sizes with a planar active surface area ranging from about 1 cm² to about 1 m²; or from about 1 cm² to about 10 cm²; or from about 10 cm² to about 50 cm²; or from about 50 cm² to about 100 cm²; or from about 100 cm² to about 1 m²; or greater than about 1 m². The hybrid electrolyzer systems in accordance with many embodiments are modular and scalable.

In many embodiments, the hybrid electrolyzer systems can store the generated protons for an extended period. The stored protons can be supplied on demand when generation of gaseous hydrogen is needed.

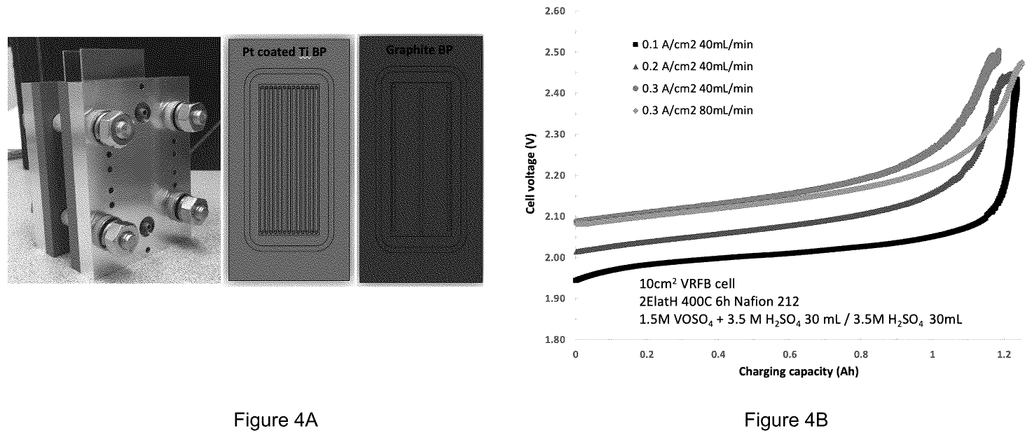

Some embodiments implement 10 cm² vanadium-oxygen (V-O₂) hybrid flow cells as the hybrid electrolyzer systems. The cells can perform at room temperature (from about 20° C.to about 25° C.) Some embodiments use Elat-H as cathode electrode, iridium oxide-coated (IrOx) platinized titanium as anode electrode, Nafion® 212 as the membrane, and vanadium sulfate: VOSO₄, sulfuric acid: H₂SO₄ as electrolytes. FIG. 4A illustrates a 10 cm² hybrid flow cell as a hybrid electrolyzer system in accordance with an embodiment. FIG. 4B illustrates charging voltage behaviors with different current densities and flow rates at room temperature of the hybrid electrolyzer system in accordance with an embodiment. The effects of doubling flow rates at current density of about 0.3 A cm⁻² is noticeable at high state-of-charge (SOC) (greater than about 70%), resulting in much lower voltage and reduced hydrogen evolution. The cell average voltage at 0.3 A/cm² is about 2.17 V.

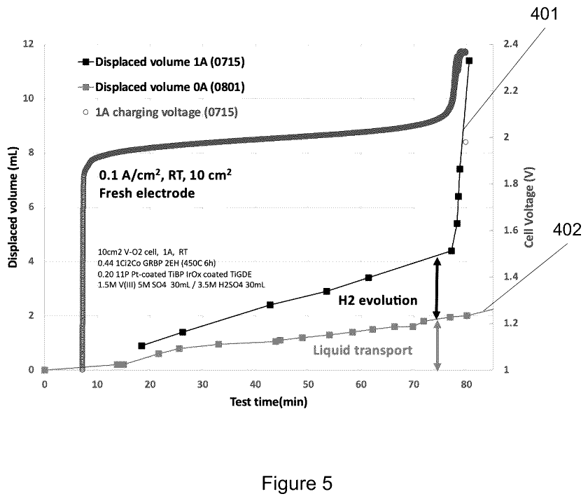

FIG. 5 illustrates displaced volume measured in the vanadium reservoir during the charging and equivalent time without current in accordance with an embodiment. 401 shows displaced volume measured in the vanadium reservoir during the charging process. 402 shows the equivalent time as 401 but without current. Vanadium crossover rate is estimated and summarized in Table 1 for four different test cases shown in FIG. 5.

TABLE 1
Summary of vanadium ion cross-over rate of a 10
cm² V—O₂ hybrid flow cell in different test conditions.

| Tests | | | | |
|---|---|---|---|---|
| | Current | | Anolyte reservoir | Cross- |
| Temperature | density | Flow rate | Concentration of | over |
| (° C.) | (A cm⁻²) | (mL min⁻¹) | vanadium (mmol L⁻¹) | rate (%) |
| 25 | 0.1 | 40 | 1.85 | 0.11 |
| 25 | 0.2 | 40 | 3.95 | 0.24 |
| 25 | 0.3 | 40 | 3.21 | 0.21 |
| 25 | 0.3 | 80 | 4.16 | 0.25 |

The cross-over rate is defined by the ratio of equivalent charge of transported vanadium and the actual amount of charge based on the applied current and time. The vanadium cross-over rates per single charge in a 10 cm² cell are less than about 0.3%. The selectivity is defined as vanadium conversion rate (V³⁺→V²⁺) per electricity input during the charging process, which can be quantified by estimating hydrogen evolution rate. To measure hydrogen evolution, several embodiments measure the displaced volume in the vanadium reservoir which is caused by 1) hydrogen evolution, and 2) water transport across the membrane from the positive reservoir to the negative reservoir. To separate the hydrogen evolution and water transport, displaced volume is measured in the same condition except for no current as shown in 402 in FIG. 5. Hydrogen evolution reaction is very small up to the mass transport limiting condition, which appears as a rapid voltage increase. The selectivity is estimated to be about 98% at the fully charged condition. The selectivity is about 99.5% at up to 80% state-of-charge.

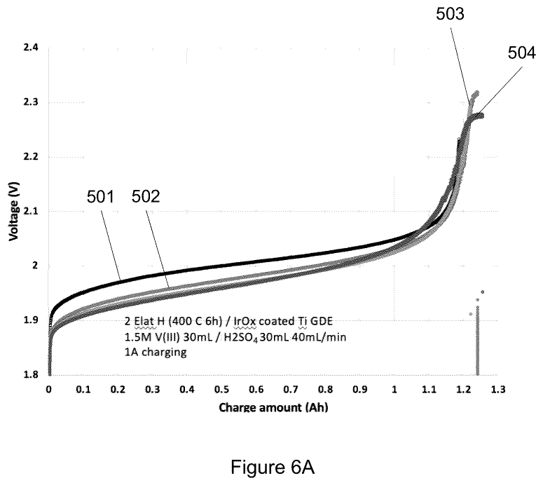

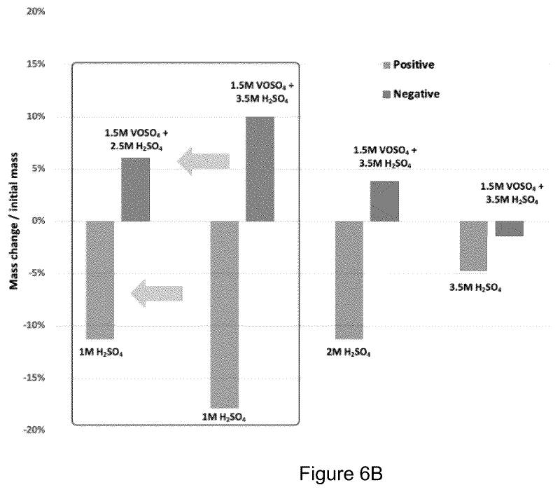

Several embodiments optimize catholyte and anolyte compositions in order to decrease the cell operating voltage during the charging. Some embodiments lower acidity in the anolyte to help reduce half-cell equilibrium potential of the anode, leading to lowering the cell operating voltage. FIG. 6A illustrates charging voltage profile (left) at 1 A cm⁻² and ambient temperature with different compositions of anolytes and catholytes in accordance with an embodiment. The measurements are carried out at room temperature (between about 20° C.to about 25° C.), with Elat-H as cathode, IrOx coated titanium gas diffusion electrode (GDE) as anode, Nafion® 212 as the membrane. The charging current density is about 0.1 A/cm². 501 shows the voltage profile of 1.5 M VOSO₄+3.5 M H₂SO₄ as catholyte and 3.5 M H₂SO₄ as anolyte. 502 shows the voltage profile of 1.5 M VOSO₄+3.5 M H₂SO₄ as catholyte and 2 M H₂SO₄ as anolyte. 503 shows the voltage profile of 1.5 M VOSO₄+3.5 M H₂SO₄ as catholyte and 1 M H₂SO₄ as anolyte. 504 shows the voltage profile of 1.5 M VOSO₄+2.5 M H₂SO₄ as catholyte and 1 M H₂SO₄ as anolyte. FIG. 6B illustrates electrolyte mass changes after charging in accordance with an embodiment.

FIG. 6A shows that the cell operating voltage decreases with decreased acidity in the anolyte, while the water transport to the catholyte increases. For example, for a fixed catholyte (1.5 M VOSO₄+3.5 M H₂SO₄), the cell voltage at 0.6 Ah is about 2.008V (3.5 M H₂SO₄), about 1.983V (2 M H₂SO₄), and about 1.972V (1 M H₂SO₄), while the anolyte mass change tends to increase—about 5% (3.5 M H₂SO₄), about 11% (2 M H₂SO₄), and about 18% (1 M H₂SO₄), indicating more water transport across the catholyte. For a fixed anolyte composition (1 M H₂SO₄), the decreased acidity of catholyte from 3.5 M H₂SO₄ to 2.0 M H₂SO₄ (504) shows almost similar voltage profile, while the anolyte mass change is 11%, indicating water transport can be reduced by 7% compared with the catholyte (1.5 M VOSO₄+3.5 M H₂SO₄).

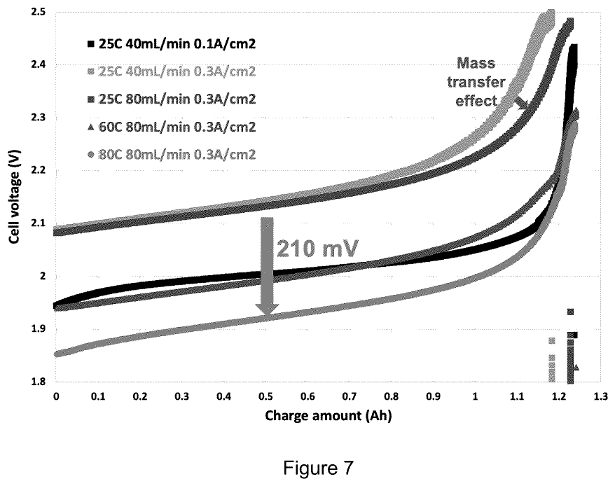

Some embodiments optimize operating temperatures and flow rates in order to further decrease the cell voltage. Increased operating temperatures and/or flow rates can further decrease the cell voltage in accordance with various embodiments. FIG. 7 illustrates cell voltage at various temperatures, flow rates, and current densities in accordance with an embodiment. FIG. 7 shows charging voltages of a 10 cm² V-O² hybrid flow cell with temperatures from about 25° C.to about 80° C., flow rates from about 40 mL/min to about 80 mL/min, and current densities from about 0.1 A/cm² to about 0.3 A/cm². The cell has Elat-H as cathode, IrOx coated titanium gas diffusion electrode (GDE) as anode, and Nafion® 212 as the membrane. 1.5 M VOSO₄+3.5 M H₂SO₄ is used as catholyte and 3.5 M H₂SO₄ as anolyte. The cell charging voltage at 0.3 A/cm² is about 1.997V at SOC 80% and its average voltage in the entire SOC range is about 1.952 V. The elevated temperature is a common operating temperature in the PEM electrolyzer, which helps reduce electrochemical activation barrier of oxygen evolution reaction as well as vanadium reduction (V³⁺→V²⁺). The vanadium ion cross-over rate at about 80° C.and a single full charge is less than about 1%, though slightly increased with temperature (0.98% at 80° C. vs 0.25% at 25° C.) Coulombic efficiency can be estimated by quantifying hydrogen side reaction amount during the charging. The hydrogen evolution side reaction rate at ambient temperature can be estimated by measuring the displaced volume in the vanadium reservoir but the direct measurement at the elevated temperature test condition is challenged due to heat loss and thermal expansion. Instead, based on findings that the voltage change behavior is similar to the displaced volume behavior and the solution color is changed to purple with approaching about 100% SOC, hydrogen evolution rate can be estimated. In FIG. 7, the voltage curves at 80° C. and 25° C.(red and black color) are overwrapped, indicating a similar hydrogen evolution behavior. Conservatively, the coulombic efficiency at 80° C. can be greater than 97%. Table 2 summarizes the cell voltage at 50% SOC, 80% SOC, and the average voltage.

TABLE 2
Cell voltage at 50% SOC, 80% SOC, and the average voltage at
different temperatures, current densities, and flow rates.

| Tests | | | | | |
|---|---|---|---|---|---|
| | Current | | | | |
| Temperature | density | Flow rate | V50% | V80% | Vavg |
| (° C.) | (A cm⁻²) | (mL min⁻¹) | (V) | (V) | (V) |
| 25 | 0.1 | 40 | 2.010 | 2.051 | 2.024 |
| 25 | 0.3 | 40 | 2.155 | 2.267 | 2.184 |
| 25 | 0.3 | 80 | 2.144 | 2.226 | 2.171 |
| 60 | 0.3 | 80 | 2.003 | 2.073 | 2.026 |
| 80 | 0.3 | 80 | 1.932 | 1.997 | 1.952 |

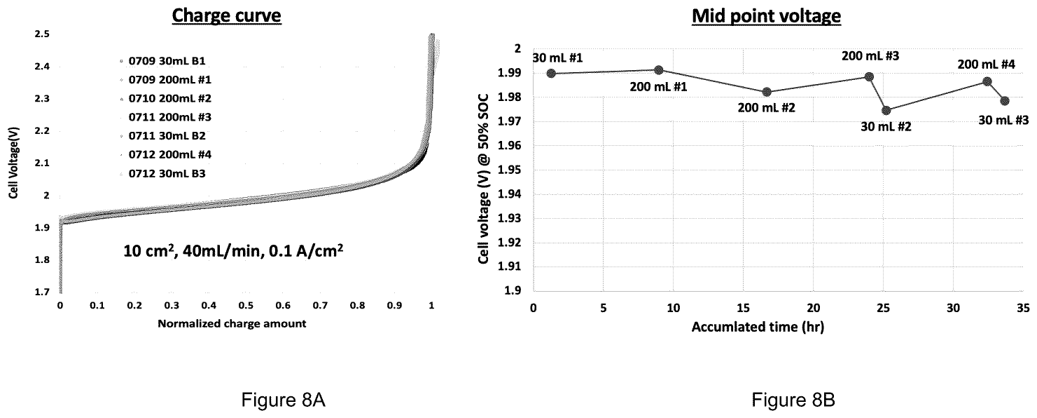

A duty cycle operation can be used for the stability test. The stability of the flow cell performance is tested with intermittent rest periods (at least 7 h) between about 8 hours continuous operation. Before the 8-hour continuous test, the baseline test with 30 mL vanadium electrolyte is conducted. To evaluate the degradation, the identical baseline test is conducted using the same stock vanadium solution. Deionized (DI) water and 1.5 M V³⁺+2.25 M S solution is used as anolyte and catholyte respectively. The flow cell is drained after the 8-hour charging test and is held for more than 7 hours at rest in the sealed condition. The anolyte (DI water) is reused to evaluate the accumulated vanadium cross-over. FIG. 8A illustrates stability of charging voltage profiles of a 10 cm² V-O2 flow cell using 1.5 M V³⁺+2.25 MS (catholyte) and DI water (anolyte) in accordance with an embodiment. FIG. 8B illustrates the mid-point voltages to evaluate the degradation in accordance with an embodiment. FIG. 8A shows charging voltage profiles of four 200 mL vanadium tests and three 30 mL baseline tests with DI water at 0.1 A cm⁻² and 40 mL min 1. FIG. 8B shows almost no flow cell degradation, while the performance is slightly improved for 35 hours: the charging voltage is decreased with time (−0.33 mV h⁻¹). In this test, the IrOx-coated non-platinized titanium (Ti) GDE is used as an anode because IrOx-coated platinized Ti GDE may cause a hydrogen evolution issue in the vanadium side. The anolyte (0.5 mL) is sampled prior to the 8-hour operation to investigate the accumulated vanadium cross-over effect. Anolyte with different tests shows almost clear colors, implying accumulated vanadium crossover is not significant.

### Catalytic Reactor System

The catalytic reactors can range in size from small, appliance-size equipment that is well-suited for small-scale distributed hydrogen production to large-scale, central production facilities that could be tied directly to renewable or other non-greenhouse-gas-emitting forms of electricity production.

Various catalysts that can catalyze hydrogen generation reaction with the redox couple can be used for the catalytic reactor systems. In several embodiments, the catalysts catalyze vanadium oxidation reactions and hydrogen reduction reactions. The catalysts or the catalytic materials can include an active catalyst and a porous material with large surface area as catalyst support. Catalysts can be in a form of powders, beads, or spheres. The active catalyst can contain at least one metal element including (but not limited to) aluminum (Al), yttrium (Y), lanthanum (La), iron (Fe), molybdenum (Mo), tantalum (Ta), tungsten (W), niobium (Nb), manganese (Mn), chromium (Cr), titanium (Ti), zirconium (Zr), nickel (Ni), zinc (Zn), tin (Sn), cerium (Ce), palladium (Pd), cobalt (Co), platinum (Pt), and gold (Au). Examples of catalyst nanoparticles include (but are not limited to) molybdenum carbide nanoparticles, iron-based sulfides nanoparticles. Desired phase of the catalyst can be achieved for the catalytic reactor systems. The nanoparticles can be core-shell particles. The catalyst nanoparticle packing density and/or pore size can be controlled. Some embodiments select nanoparticles of specific geometries for the catalyst. Examples of nanoparticle geometries include (but are not limited to), tubes, nanowires, sheets, cubes, rods, platelets, cubes, various polyhedral and any combinations thereof. In some embodiments, catalyst nanoparticles may have an average pore size ranging from about 0.1 nm to about 500 nm; or from about 0.1 nm to about 100 nm; or from about 0.1 nm to about 50 nm; or from about 0.1 nm to about 10 nm; or from about 0.1 nm to about 5 nm; or from about 0.1 nm to about 1 nm. The catalysts can be deposited on catalyst support materials. Catalyst support materials should be stable in the electrolyte under still conditions; or under various stir speeds from about 100 rpm to about 500 rpm. In many embodiments, catalyst support materials can include (but are not limited to) ceramics, zeolites, oxides, nitrides, borides, carbides, and other carbon-based particles. In a number of embodiments, the catalytic reactions can be expedited via stirring and/or heating.

In many embodiments, the catalyst chambers can be made with materials that are compatible with the reaction conditions. The catalyst chamber materials in accordance with several embodiments are mechanically and chemically stable under acidic conditions (for example pH less than or equal to about 3; or pH less than or equal to about 2), resistant to corrosion, and compatible with gaseous hydrogen and resistant to hydrogen embrittlement. Examples of suitable materials for catalyst chambers include (but are not limited to) nickel-chrome based alloys, nickel-iron-chrome based alloys, Inconel® alloys, Inconel® 625, Incoloy® alloys, Incoloy® 20, Hastelloy® alloys, and Hastelloy® C-276.

Several embodiments modify the catalytic reactor designs and operations such as (but not limited to) the catalyst placement, head space volume, flow rate of the charged electrolyte, the spatially and temporally resolved discharge rate of the vanadium redox couples and hydrogen generation rate, the heat transfer and the temperature changes during the catalytic discharging process in the reactor and its impact on the resulting pressure, in order to achieve the desired performance. The modification can be done via simulations using such as multi-physics models.

Some embodiments provide chemical stability assessments of catalyst supports: molecular sieve (KₙNa₁₂₋ₙ[(AlO₂)₁₂(SiO₂)₁₂]xH₂O) and gamma-alumina oxide (γ-Al₂O₃). The catalyst supports are immersed in DI water and 3.5 M H₂SO₄ solution for various time durations (about 1 hour; about 2.5 hours; about 10 hours; about 22 hours), and under conditions (such as keeping the solution still; stirring the solution at about 500 rpm). The molecular sieve support is mechanically stable, but not chemically stable in 3.5 M H₂SO₄ solution and quickly degrades during the hydrogen generation. In comparison, the alumina oxide shows better chemical stability and mechanical stability than the molecular sieve in the 3.5 M H₂SO₄ solution. The results of the stability evaluation establish the enduring stability of the alumina oxide support within the 3.5 M H₂SO₄ solution.

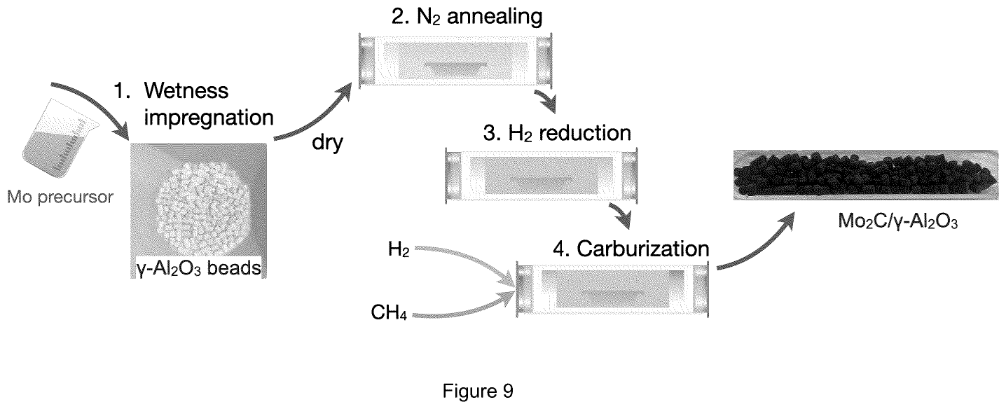

FIG. 9 illustrates a synthesis schematic of the catalyst in accordance with an embodiment. FIG. 9 shows that the catalyst synthesis starts with the molybdenum (Mo) loading onto catalyst support. The chosen Mo precursor solution (ammonium molybdate (para) tetrahydrate) can be thoroughly mixed with γ-Al₂O₃. Subsequently, two drying methods are employed: the wetness impregnation method involving graduate drying at about 40° C.(wetness impregnation method), and the incipient wetness impregnation method performed at room temperature under vacuum. The resultant Mo-loaded Al₂O₃ samples are then transferred into a tube furnace and annealed at about 400° C., followed by a H₂ reduction at about 850° C., and the carburization under H₂/CH₄ mixture gas to yield the catalyst.

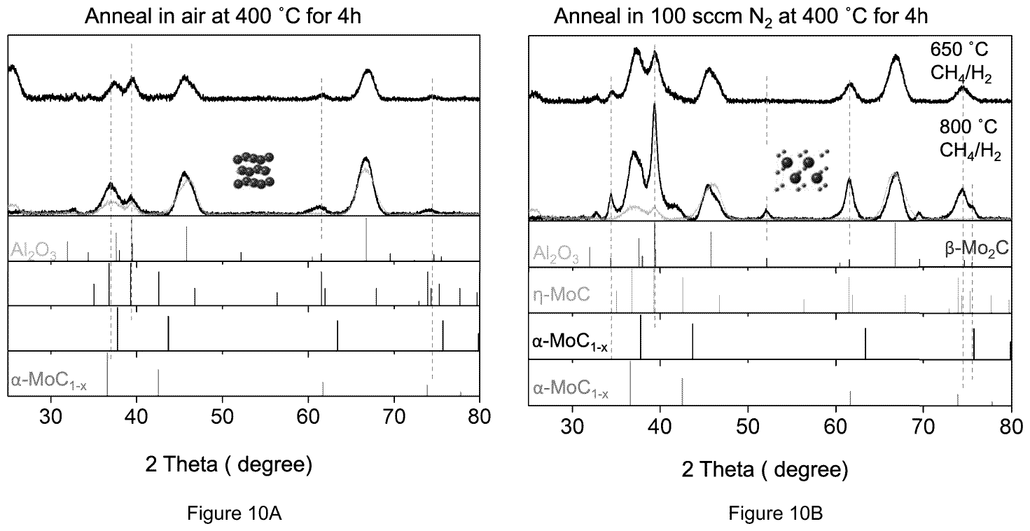

The modulation of the molybdenum carbide (MoxCy) phase can be readily achieved by varying the annealing gas atmosphere. The powder X-ray diffraction (pXRD) measurements confirm the emergence of alpha phase (α-MoC1-x) when calcining Mo-loaded alumina oxide to air, and the formation of the beta phase (B-Mo₂C) under a nitrogen atmosphere. FIGS. 10A and 10B illustrate XRD patterns of Al₂O₃ supported MoₓC_{y} catalysts annealed in air and nitrogen respectively in accordance with an embodiment. Despite elevating the carburization temperature from about 650° C.to about 800° C., no alternations in the resultant MoₓC_{y} phase are discerned; however, an increase in particle size is observed as shown in FIGS. 10A and 10B.

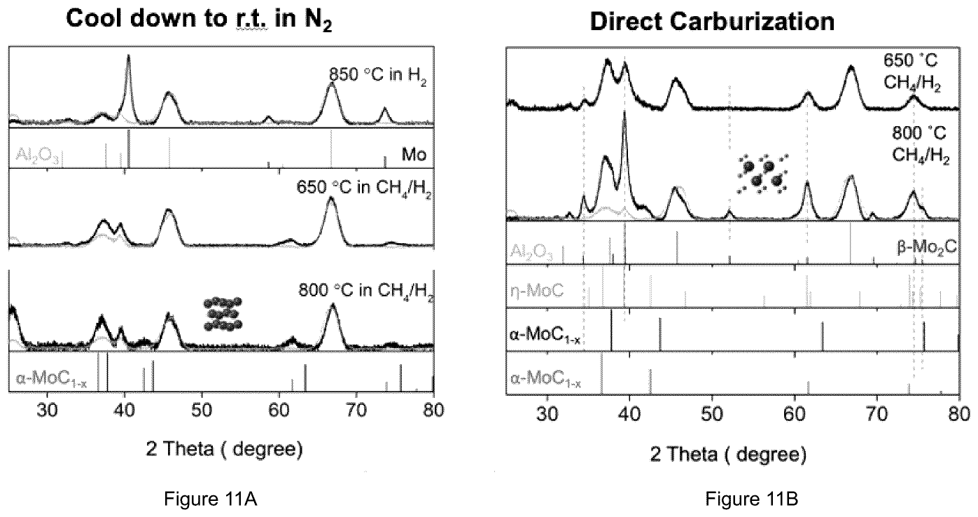

The process of in situ reduction and carburization may be important in the formation of β-Mo₂C phase. Upon reduction at about 800° C. within a hydrogen flow, the metallic molybdenum can be formed. Directly following this reduction, the immediate in situ carburization facilitates the transformation into β-Mo₂C. Conversely, if the metallic molybdenum is allowed to cool to room temperature under nitrogen flow, and subsequently subjected to carburization at elevated temperatures, the resulting catalyst may predominantly be α-MoC₁₋ₓ. FIGS. 11A and 11B illustrate pXRD patterns of ex-situ and in-situ carburized catalysts in accordance with an embodiment.

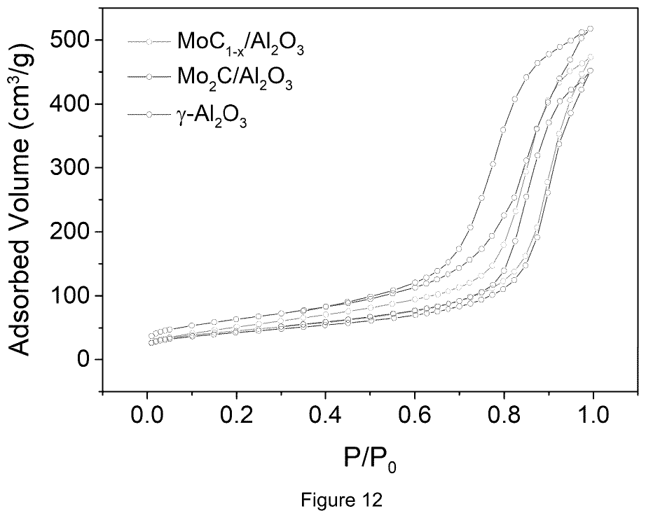

The quantification of the surface area of the obtained catalysts can be conducted via the nitrogen adsorption-desorption isotherm. FIG. 12 illustrates nitrogen isotherm of Al₂O₃ support and MoₓC_{y}/Al₂O₃ catalysts in accordance with an embodiment. The initial alumina support has a BET surface area of about 228 m²/g, rendering it suitable for accommodating a greater quantity of Mo precursor. A minor reduction in surface area attributed to the catalyst loading process is shown in Table 3. This minimal decrease suggests that the MoₓC_{y} nanoparticles (with a size of about 5 nm) do not significantly obstruct the pores within the support.

TABLE 3
Summary of BET surface area, pore volume and pore
size of Al₂O₃ support and MoₓC_{y}/Al₂O₃ catalysts.

| | Surface area | Pore volume | Pore size (nm) |
|---|---|---|---|
| Sample | (m²/g) | (cm³/g) | Peak (ad/de) |
| Al₂O₃ | 228 | 0.8 | 13/10 |
| β-Mo₂C/Al₂O₃ | 152 | 0.7 | 19/13 |
| α-MoC₁₋ₓ/Al₂O₃ | 162 | 0.73 | 19/13 |

In certain embodiments, a small-scale synthesis (about 20 g) of gamma-alumina oxide-supported alpha or beta phase molybdenum carbide catalyst, with about 10 wt. % molybdenum loading, can be accomplished using the wetness impregnation method within a single batch.

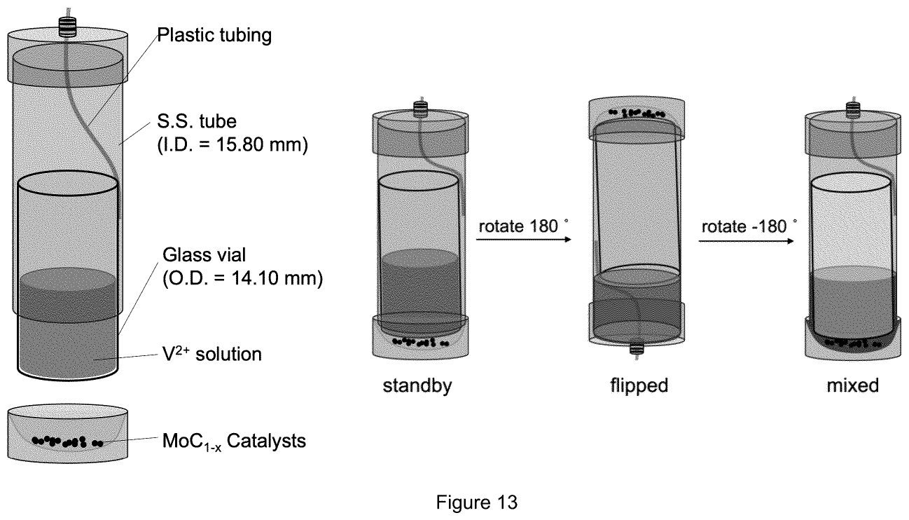

Several embodiments provide kinetic data under ambient pressure (about 1 bar). To gather kinetic data essential for catalytic reactor design, the measurement of initial hydrogen generation rate is conducted utilizing the reactor design illustrated in FIG. 13. FIG. 13 illustrates a schematic of the designed reactor for rate measurement in accordance with an embodiment. The main design concept is the isolation of both the catalysts and the V²⁺ solution ahead of the catalytic reaction. The reactor can be then agitated by two flips to achieve thorough mixing and initiate the reaction. The system is sealed, with the overall pressure being continuously monitored via a flow meter.

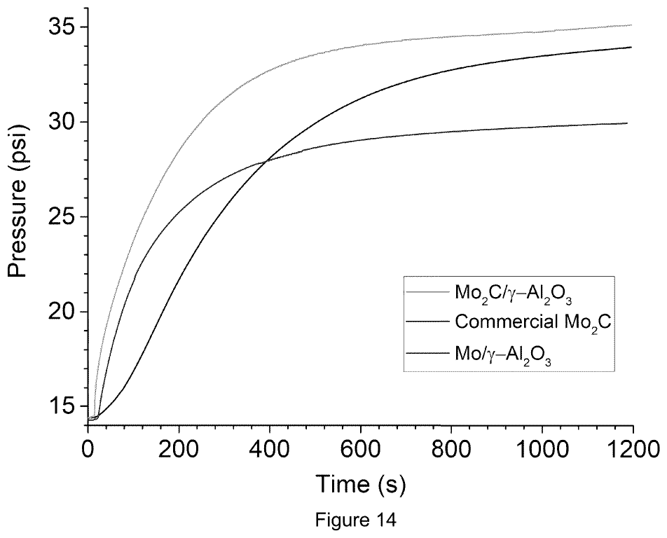

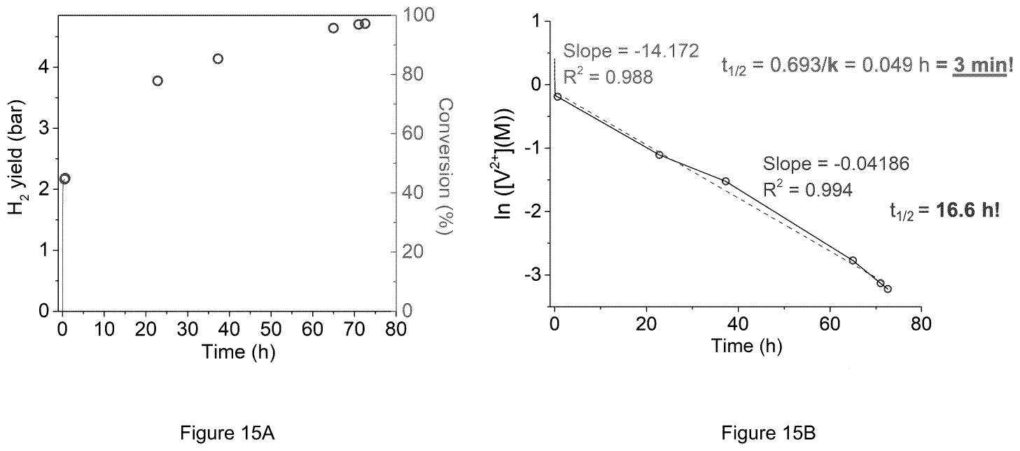

FIG. 14 illustrates initial rate measurement with different catalysts in accordance with an embodiment. Mo₂C/Al₂O₃ catalyst may have a mass activity about 4 times higher than that of the commercial Mo₂C catalyst. The metallic Mo/Al₂O₃ also shows the activity to hydrogen generation. Table 4 summarizes the hydrogen generation rate with different catalysts.

TABLE 4
Summary of initial hydrogen generation
rate with different catalysts.

| | Rate/Active catalyst mass | Rate/Total catalyst mass |
|---|---|---|
| Catalysts | (mol-H₂/s/g-MoₓC_{y}) | (mol-H₂/s/g-catalyst) |
| Mo₂C/Al₂O₃ | 0.128 | 0.013 |
| Mo/Al₂O₃ | 0.088 | 0.009 |
| Commercial Mo₂C | 0.037 | 0.037 |

FIG. 15A illustrates hydrogen yield in bar and conversion (%) over time in accordance with an embodiment. The reaction uses about 3 mL of electrolyte and the pressure is monitored and recorded using flow meter. FIG. 15B illustrates calculated In [V²⁺] fitted with time in accordance with an embodiment. The kinetics of the synthesized Mo₂C catalyst reveal that the reaction is thermodynamically favored yet constrained by its kinetic behavior. Starting from ambient pressure (about 1 bar), the conversion of hydrogen may reach to about 50% within 3 minutes, about 60% at 30 minutes, and about 80% after 12 hours as shown in FIG. 15A. Through fitting reactant concentration versus time, the reaction follows the first order reaction and comprises two stages, each characterized by a different reaction rate. In the initial several minutes, the reaction exhibits a small half-life of about 3 minutes, while in the subsequent phase, the half-life extends to about 16.6 hours. To improve the kinetics, additional stirring can be applied.

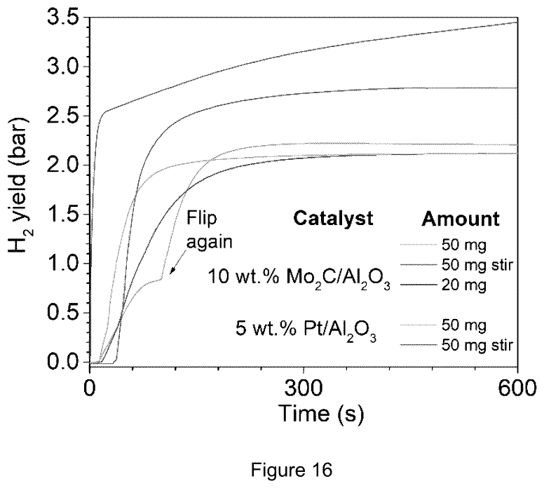

The ground samples can be utilized to investigate the intrinsic activity of Mo₂C/Al₂O₃ catalysts, while stirring is introduced to further enhance reaction kinetics. FIG. 16 illustrates hydrogen yield in bar using as-synthesized Mo₂C/Al₂O₃ and commercial Pt/Al₂O₃ with and without stirring in accordance with an embodiment. As shown in FIG. 16 and summarized in Table 5, stirring effectively increases the initial hydrogen generation rate by a factor of 5. Mo₂C/Al₂O₃ catalysts show comparable catalytic performance to the commercial Pt/Al₂O₃ catalysts in the absence of stirring. With stirring applied, the reaction kinetics are accelerated 3-fold compared to the commercial catalysts. The Mo₂C/Al₂O₃ catalysts exhibit great catalytic performance.

TABLE 5
Summary of initial hydrogen generation rate
under different catalytic conditions.

Initial H₂ generation rate

| Catalyst | mass (g) | (mmol/s) | (mol/s/kg-catalyst) |
|---|---|---|---|
| Mo₂C/Al₂O₃ | 0.0506 | 0.0163 | 0.323 |
| Powder | 0.0504 | 0.0809 | 1.605 |
| | (stirring) | | |
| Pt/Al₂O₃ | 0.0501 | 0.0253 | 0.502 |
| Powder | 0.0509 | 0.0302 | 0.593 |
| | (stirring) | | |

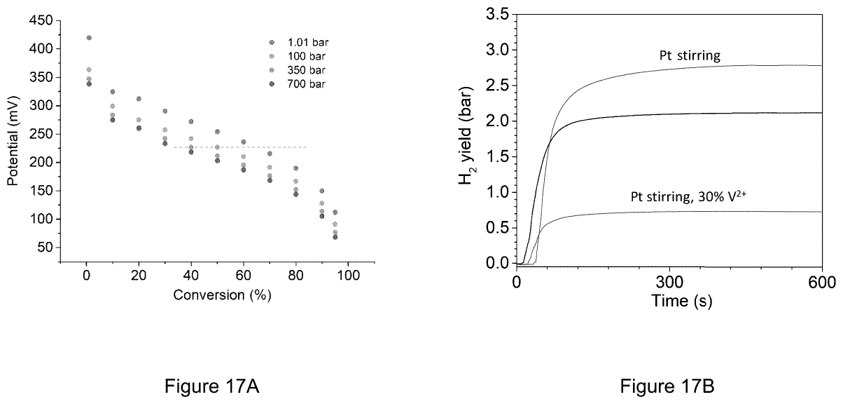

Apart from kinetics, the evaluation of reaction potentials at varying V²⁺/V³⁺ ratios and initial hydrogen pressures is performed to assess the thermodynamic driving forces. FIG. 17A illustrates calculated reaction potentials versus reaction conversions at different starting H₂ pressure in accordance with an embodiment. Table 6 summarizes the reaction potential at various starting pressures and conversion stages shown in FIG. 17A. FIG. 17B illustrates hydrogen yields of commercial Pt/Al₂O₃ using 100% and 30% V²⁺ solutions in accordance with an embodiment. A reaction potential of approximately 226 mV can be correlated with rapid reactions, which is evidenced by measured reaction rates: achieving around 80% conversion in 4 minutes at about 1 atm, approximately 68% conversion within 2 minutes at about 100 bar, and roughly 52% conversion in about 4 minutes at 350 bar. While further conversion remains attainable, it necessitates considerably elongated time. Table 7 summarizes the calculated reaction rate constant and half life time.

TABLE 6
Reaction potential (mV) at various starting pressures and conversions.

| p_{H}_{₂} (bar) | 1% | 10% | 20% | 30% | 40% | 50% | 60% | 70% | 80% | 90% | 95% |
|---|---|---|---|---|---|---|---|---|---|---|---|
| 1.013 | 419.5 | 342.7 | 312.1 | 290.4 | 271.9 | 254.2 | 235.9 | 215.4 | 189.6 | 149.6 | 112.0 |
| 100 | 363.3 | 299.2 | 275.1 | 257.5 | 242.0 | 226.6 | 210.3 | 191.3 | 166.8 | 128.1 | 91.0 |
| 350 | 347.3 | 283.3 | 259.4 | 242.1 | 226.8 | 211.6 | 195.4 | 176.6 | 152.4 | 113.7 | 76.8 |
| 700 | 338.4 | 274.5 | 250.6 | 233.4 | 218.1 | 203.0 | 186.8 | 168.1 | 143.8 | 105.2 | 68.3 |

TABLE 7
Calculated reaction rate constant and half-life time.

| Catalysts | Mass (mg) | k (h⁻¹) | t_{1/2} (s) |
|---|---|---|---|
| Mo₂C | 500 | 14.172 | 176 |
| | 50 (stir) | 294 | 8.5 |
| Pt | 50 | 31.293 | 80 |
| | 50.9 (stir) | 61.2 | 40.8 |
| 30% V²⁺ | 55.8 (stir) | 56.0 | 44.5 |

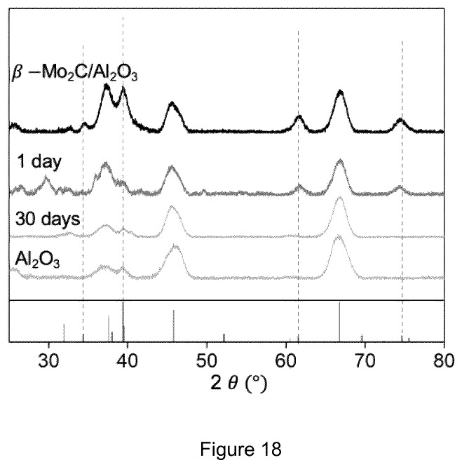

FIG. 18 illustrates X-ray Diffraction patterns of the catalysts before and after reaction in accordance with an embodiment. The used catalysts exhibit no discernible alternations in morphology after prolonged exposure to electrolyte (about 30 days) with about 3 bar hydrogen gas. This observation confirms the chemical and mechanical stability of Al₂O₃ support within the reaction electrolyte. The crystal structure of the used catalysts is examined via X-ray diffraction. The peak intensity of β-Mo₂C decreases after reaction and almost disappears in the 30 days sample. The loss of Mo₂C pattern can be attributed to the detachment of Mo₂C from the support.

Several embodiments implement Inconel® and Incoloy®-based materials as catalytic reactor materials. Mechanical stability and corrosion resistance are desired properties for catalytic reactor materials. Inconel® 625 is preferred as opposed to Incoloy® 20 for its mechanical properties. Corrosion experiments are carried out on Inconel® 625 in 3.5 M sulfuric acid solution to verify experimental rates of corrosion. A sample of Inconel® 625 is placed within 50 ml of the acid, and samples from the test solution are taken at increasing intervals of time over a 10-day experiment period. Samples are analyzed using inductively coupled plasma mass spectrometry (ICP-MS) to quantify ion concentrations in different solution samples. 5 main elements (Ni, Nb, Fe, Mo, Cr) within Inconel® 625 are analyzed. These five elements constitute about 95% of the basis of the composition for Inconel® 625. Experimental yearly corrosion rates are calculated for each element over the 10-day period. Results summarized in Table 8 from the 10-day experiment indicate that the elements (Ni, Nb, Fe, Mo, Cr) corrode at far below the target milestone of 1 mm/year constraint. Given the affinity of Inconel® 625 to resist significant corrosion in 3.5 M sulfuric acid solution, as well as its mechanical properties, Inconel® 625 can be used as a suitable material for vessel fabrication.

TABLE 8
Calculated yearly corrosion rates of 5 main
elements within Inconel ® 625.

| | | |
|---|---|---|
| Nickel | 2.14469 | nm/year |
| Niobium | 0.619871 | nm/year |
| Iron | 3.08597 | nm/year |
| Molybdenum | 0.337673 | nm/year |
| Chromium | 1.44838 | nm/year |

Some embodiments provide kinetic data of hydrogen self-pressurization for pressures up to about 350-bar. Pressurized canister hydrogen is fed into the catalytic reactor. Inconel® 625 tubing and high-pressure fittings is used to safely transport the gas. In achieving further self-pressurization, hydrogen gas flow is stopped, the catalytic reactor inlet/outlet is closed, and a release actuation mechanism drops catalyst into catalytic reactor electrolyte. In the context of batch mode reactor operation, actuation pertains to the use of any combination of pure or hybrid mechanical, magnetic, or electric schemes for catalyst release to generate additional hydrogen via the chemical reaction delineated in this disclosure. The actuation can be accomplished by materials that are both mechanically and chemically compatible with corrosive components of the reactor system, as well as stable under the targeted pressure regimes. This actuation results in additional hydrogen generation which self-compresses under the volume of the closed catalytic reactor after an initial pre-pressurization step. Following this step, downstream pressure regulation is achieved using a back-pressure regulator and safety release needle valve. The sequence of steps results in a safe, repeatable means of testing high pressure hydrogen self-compressibility.

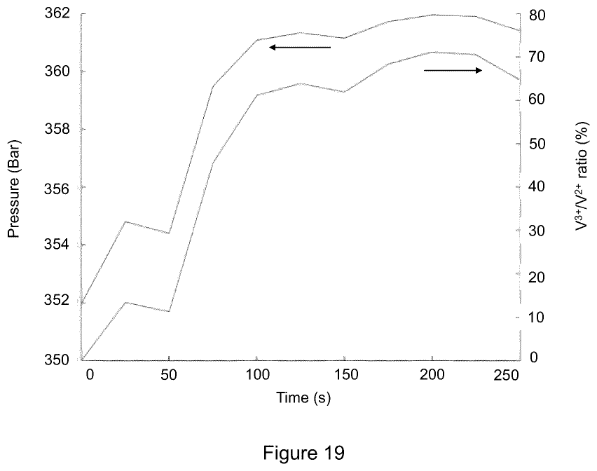

Using the described processes, hydrogen self-compressibility can be achieved at about 100 bar/350 bar. Results of the 350-bar experiment can be seen in FIG. 19 and show an increase of about 9-bar within an initial pressurization period of 4 minutes. FIG. 19 illustrates pressure and V³⁺/V²⁺ratio versus time in accordance with an embodiment. Mixing is incorporated into this experiment, which improves overall rate of reaction. The high-pressure experiments show a V³⁺/V²⁺ratio greater than about 50%, indicating that the thermodynamic driving force of the catalytic reaction is present at these higher-pressure regimes.

### Batch Reactor Mode

Several embodiments implement batch hydrogen pressurization systems for producing high pressure hydrogen. The batch reactor can actuate catalyst release, vent extra gas pressure, and pre-pressurize to about 700-bar. In some embodiments, a high-pressure hydrogen cylinder (about 6,000 psig) can be used to fill a 2.25 L Inconel® 625 double-ended sample cylinder (rated to 15,000 psig) by controlling the flow rate through a high-pressure regulator and a critical orifice. Initially, the sample cylinder can be submerged in liquid nitrogen and filled to a pressure of about 71 barg (1,045 psig) or about 133 barg (1,944 psig). The sample cylinder can then be removed from the liquid nitrogen bath and allowed to warm to room temperature. The final pressure in the cylinder can be about 350 barg (5,100 psig) or about 750 barg (11,000 psig), depending on the initial fill pressure. Upon completion, the product hydrogen gas in the sample cylinder can be slowly vented into a fume hood at a rate that when mixed with hood air flow, will result in dilution to less than about ¼ of the lower flammability limit. The high-pressure hydrogen cylinder can be used to feed high-pressure hydrogen to a reactor operated in batch mode to produce additional hydrogen through a catalytic reaction.

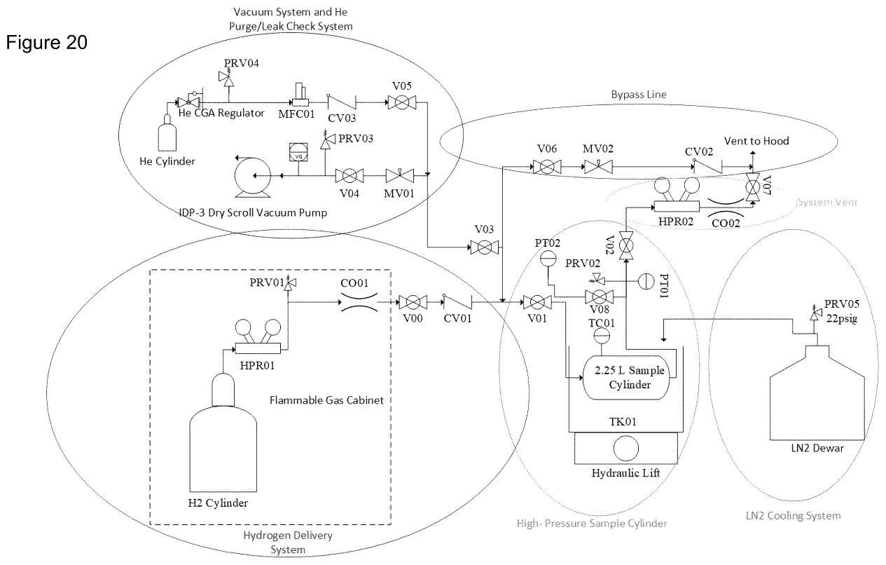

FIG. 20 illustrates a process flow diagram (PFD) in accordance with an embodiment. The system includes a high-pressure hydrogen (H₂) delivery cylinder (6,000 psig), a vacuum system to evacuate the system prior to H₂ introduction, a helium (He) purge/leak test system, a liquid nitrogen (LN₂) cooling system, a high-pressure sample cylinder for hydrogen pressurization, a system vent, and a bypass line.

Some embodiments provide hydrogen delivery systems in the batch reactor mode. A 6,000 psig H₂ cylinder can be used as the H₂ feed to the 2.25 L sample cylinder. The cylinder comes with a compatible regulator (e.g., model 2900 CGA 703) that includes a 400-6,000 psig delivery pressure with ¼″ NPT male outlet stainless steel needle valve. Pressure relief (PRV⁰¹) can be set to 3,400 psig. Downstream of the regulator (HPR01) is a critical orifice (rated to 4,000 psig), a check valve (rated to 15,000 psig), and a ball valve rated to 15,000 psig. The critical orifice (BLP-2-SS) can limit flow to about 10 SLPM and has an orifice diameter of 0.002″. The critical orifice, the H₂ regulator (HPR01), the pressure relief valve (PRV01), and the H₂ cylinder can be in ventilated flammable storage. The ball valve (V00) can be in the fume hood and allow the user to manually stop H₂ flow. The check valve (CV01) can prevent back flow. V01, V02, V03, and V06 are ball valves rated to 15,000 psig and can isolate the sample cylinder, the vacuum and He purge/leak check system, and bypass line, respectively, from the hydrogen delivery system.

Certain embodiments provide vacuum systems and helium purge and/or leak check systems in the batch reactor mode. A vacuum pump (dry scroll vacuum pump) can be located near the exhaust outlet of the system. This pump is used to provide a rough vacuum to evacuate air from the system prior to pressurization with hydrogen. The pump has a design that provides hermetic isolation of the pumped fluid. It is capable of about 60 LPM flow and 250 mTorr base pressure. The motor rating is 120 W and is in NTRL compliance. The power requirements are 115 VAC/60 Hz/1q. The exhaust of the pump is vented to the fume hood. All valves and fittings on the vacuum system can be Swagelok compression fittings. The vacuum pump system includes a vacuum gauge (VG) to monitor pressure, a pressure relief valve (PRV03 setpoint about10 psig) to protect the vacuum pump, a ball valve (V04) to isolate the vacuum pump, and a metering valve (MV01) to control the vacuum flowrate.

A He purge and leak check system is shown in FIG. 20. The system includes a He cylinder with a CGA 580 regulator, a pressure relief valve (PRV04 setpoint about 120 psig) to protect the mass flow controller, a mass flow controller (MFC01) to control the flow of He into the system, a check valve (CV02) to prevent back flow, and a ball valve (V05) to isolate the He supply. The vacuum system and He purge/leak check system are protected from high pressure by the manual ball valve (V03) that is rated to 15,000 psig. The He source can be used to purge the sample cylinder and to pressurize the system to perform a He leak test.

Some embodiments provide high-pressure sample cylinders in the batch reactor mode. The sample cylinder (FAV part number: FSC2250-4N15) can be constructed of Inconel® 625 which is rated for hydrogen, cryogenic temperatures, and pressure up to about 15,000 psig. The internal volume of the sample cylinder is about 2.25 L with an outer diameter of about 12 cm and a total length of about 43.5 cm. The sample cylinder is double ended with an inlet and outlet with P NPT-F ¼″ threads. The NPT fittings on the sample cylinder can be seal welded. Downstream of the sample cylinder, PT01 (rated to 1500 barg or about 22,000 psig, and hydrogen compatible) can monitor the cylinder pressure during pressurization with the H₂ cylinder and then pressurization while warming to room temperature. PT102 (0-150 psig) can be protected by a high-pressure ball valve (V108) to monitor pressure during helium leak test and subsequent pressure decay tests. The objective is to pressurize the cylinder to about 350 barg or about 750 barg at room temperature in two separate experiments. PRV⁰² can be set to about 15,000 psig, respectively, for each experiment which is about 3,000 psig more than the minimum rated component (the sample cylinder at about 15,000 psig). Calculations indicate that at about 77K a fill pressure of about 1,045 psig can warm to about 350 barg at room temperature and at about 77K a pressure of about 1,944 psig can warm to about 750 barg at room temperature. As these cold pressures are achieved, the sample cylinder can be isolated by closing V01 and V02 (V02 is closed during filling).

Several embodiments provide liquid nitrogen cooling systems in the batch reactor mode. LN2 can be used to fill TK01 (Styrofoam container with internal dimensions of 30.5″×14″×12.5″ with a sheet metal box as secondary containment surrounding the Styrofoam) so that the sample cylinder can be submerged in a bath of LN2 to cool the sample cylinder to 77K prior to pressurization with H₂ gas. The temperature can be monitored with a thermocouple (TC01) attached to the sample cylinder. TK01 will be partially filled with LN₂. The Dewar is supported by a hydraulic lift that is used to raise and lower TK01. The hydraulic lift (rated to about 500 lbs) can be raised until the sample cylinder is completely contained within TK01. Then, additional LN₂ can be added to maintain a liquid level above the top of the sample cylinder so that the sample cylinder is submerged. Manual control of the liquid level can be maintained by opening or closing the Dewar ball valve (not shown in FIG. 20). LN₂ personal protection equipment such as a face shield, lab coat, and LN₂ rated gloves should be dawned by the operator maintaining the LN₂ level during filling and pressurization. H₂ gas may not condense at LN₂ temperatures, but oxygen can condense so it is important to purge/evacuate the system prior to cooling. The LN₂ cooling system can be inside the fume hood and covered with a loose-fitting lid to make sure N₂ flows out through gaps and prevents O₂ condensation in the LN_{2.}

At any time, the pressure can be released by opening valve V02 and adjusting HPR02 to an outlet pressure less than about 4,000 psig to limit the amount of H₂ flow because of the inline critical orifice (CO02) to about 10 SLPM being vented to the hood. The fume hood provides adequate flow (400 ft³/min) to dilute the H₂ to well below 1% which is ¼ of the lower flammability limit for H₂.

During startup, it may be necessary to purge out air components by directing flowing through V06 and venting to the hood. For instance, this might be necessary during a H₂ bottle exchange where the broken connections are now air filled. This can be done at low pressure and the flow will be limited to about 10 SLPM by the critical orifice (CO01). Again, the hood minimum flow rate will dilute the H₂ to well below 1% which is ¼ of the lower flammability limit for H₂.

### Continuous Reactor Mode

Several embodiments implement continuous reactor systems for producing high pressure hydrogen. In certain embodiments, high-pressure vessels such as gas/liquid separators can be used to separate the gaseous hydrogen and the liquid. Some embodiments implement inline monitoring systems such as using ultrasonic non-invasive liquid level sensor in the gas/liquid separator to monitor the liquid level. Several embodiments implement inline monitoring systems such as using UV-vis to monitor the redox states of the redox couples to ensure a desired redox state and concentration is reached.

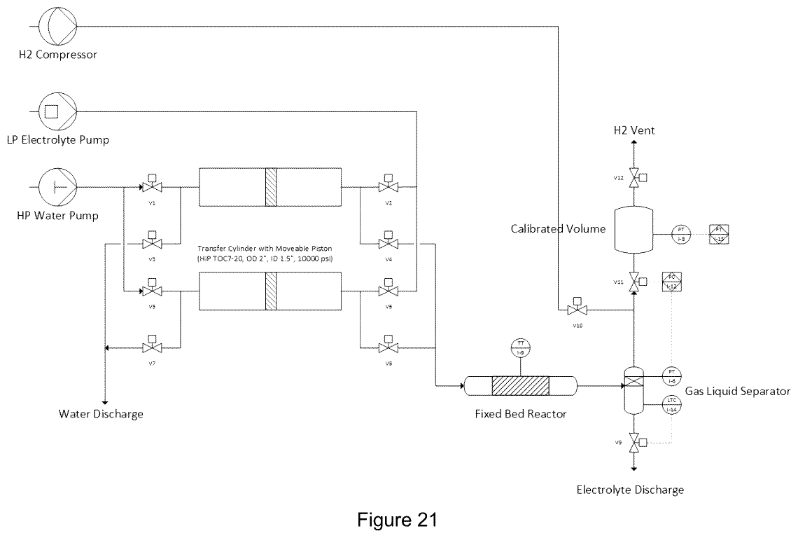

FIG. 21 illustrates a continuous 700-bar plug flow reactor to produce hydrogen (H₂) in accordance with an embodiment. This design includes a high-pressure water pump, a low-pressure electrolyte pump, a H₂ compressor, two-transfer cylinders with movable pistons, eight solenoid valves, a fixed bed reactor, a calibrated volume, and instrumentation including pressure transmitters, liquid level sensor, and thermocouples. This may be a complicated design that requires water to pressurize the sulfuric acid with vanadium solution by having critical timing of the solenoid valves to drive the pressurized solution to the fixed bed reactor and produce hydrogen. The two-transfer cylinder with movable pistons design is constructed because there is not a pump compatible with sulfuric acid that operates at 700-bar. In addition, all equipment in contact with sulfuric acid solution such as the transfer cylinders, solenoid valves, etc, may need to be custom made from a compatible material such as Inconel® 625 or Hastelloy® C-276. In addition, a H₂ compressor is implemented to generate the back pressure required on the catalyst bed.

Several embodiments utilize a simpler and cheaper method which uses a back-pressure regulator (BPR) rated to 700 bar where the reference pressure for the dome loading is generated using a hydraulic pump (hand operated) with a bleed valve to let off the pressure. Then the water driven feed pumps deliver feed, it overflows the catalyst bed and drains out the drain valve. If H₂ is generated at the catalyst bed it accumulates in the gas liquid separator until the ultrasonic meter says its tube section is gas filled. At that point the drain closes and pressure starts increasing as higher-pressure feed compresses the bubble in the separator until pressure is high enough to open the BPR and allow hydrogen to enter the calibrated volume.

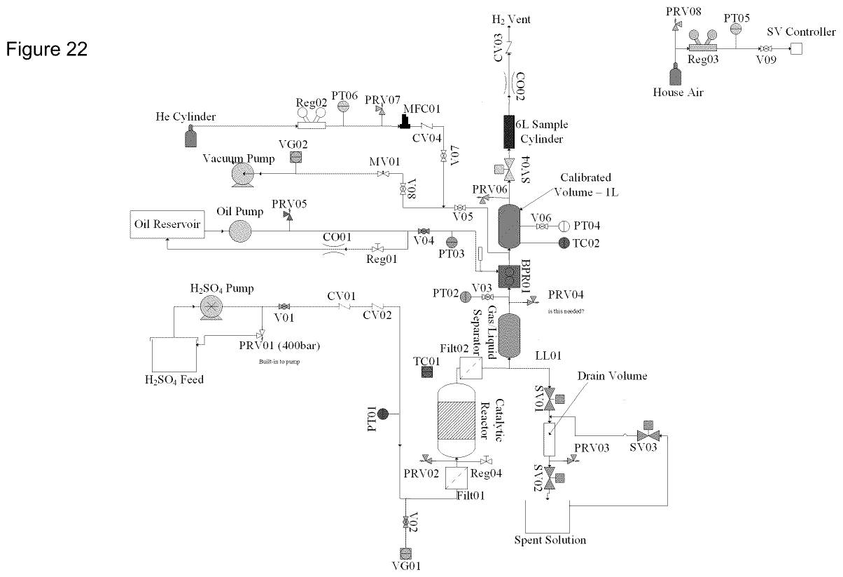

FIG. 22 illustrates a continuous design of a 350-bar plug flow reactor to produce hydrogen in accordance with an embodiment. The design in FIG. 22 has a lower pressure requirement of about 350-bar. A sulfuric acid compatible pump rated to about 350-bar replaces the high-pressure water pump, the two-transfer cylinders with a removable piston, the solenoid valves (V1-V8) and the low-pressure electrolyte pump which simplifies the process in addition to requiring fewer custom components that results in a less expensive design. The sulfuric acid pump rated to 350-bar has wetted parts compatible with sulfuric acid. The design includes instrumentation and equipment necessary to operate the plug flow reactor, recycle the spent solution, and quantify the amount of hydrogen produced.

In a continuous reactor as shown in FIG. 22, the feed solution which contains sulfuric acid and vanadium solution is pumped into a catalytic reactor where V²⁺ is converted to V³⁺ and H₂ is generated. The solution enters a gas/liquid separator where an ultrasonic non-invasive liquid level sensor is used to monitor the liquid level. As H₂ is generated, the pressure can increase creating the head pressure that is controlled by the back-pressure regulator. The dome on the back-pressure regulator is loaded by an oil pump to the desired pressure ramping up to about 350-bar. Once liquid is monitored in the gas/liquid separator, the spent vanadium 3+ rich liquid is discharged through the three-solenoid valve system and can be converted and recycled back to the feed material. As the H₂ in the head space of the gas/liquid separator exceeds the dome pressure of the BPR, hydrogen will be collected in a calibrated volume where the volume is known, the temperature and pressure are monitored and the amount of H₂ collected can then be calculated. Once the desired amount of hydrogen is collected, SV04 can be opened and the collected H₂ is expanded into a sample cylinder to reduce pressure and vented into the fume hood.

The solenoid valves are air actuated by a controller. Instrumentation such as liquid level, pressures, temperatures, and flow rates are all controlled by a programmable logic controller (PLC) that is used as a data acquisition and control system (DAS) to monitor/log process data. The auxiliary equipment that is not part of the continuous operation but needed for start-up include a helium purge system and a vacuum system to remove air components from the system prior to operation.

### Doctrine of Equivalents

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A gaseous hydrogen generation system comprising:
an electrochemical cell comprising:
a cathode that reduces a redox couple in an electrolyte, wherein the reduction reaction is not a hydrogen evolution reaction; and
an anode that oxidizes an oxygen evolution reaction to generate a plurality of protons in the electrolyte;
a reactor to receive the protonated electrolyte, wherein the reactor comprises a catalyst to catalyze a reaction that oxidizes the reduced redox couple and reduces the plurality of protons to a gaseous hydrogen, and generate a discharged electrolyte; and
a pressurized container to receive the discharged electrolyte and the gaseous hydrogen, wherein the gaseous hydrogen separates from the discharged electrolyte such that a pressurized gaseous hydrogen is collected and the discharged electrolyte flows to the electrochemical cell;
wherein the pressurized gaseous hydrogen has a pressure of at least 700 bar.

2. The system of claim 1, further comprises a transfer cylinder with a moveable piston separating the transfer cylinder into a first chamber and a second chamber;
wherein the second chamber receives the protonated electrolyte from the electrochemical cell; wherein a pump pressurizes an aqueous solution in the first chamber to move the piston towards the second chamber and pressurize the protonated electrolyte into the reactor, such that the pump is not in physical contact with the protonated electrolyte.

3. The system of claim 1, wherein the electrochemical cell has a configuration of a flow cell, a flow stack, or a flow assembly.

4. The system of claim 1, wherein the redox couple dissolves in an aqueous solution and is selected from the group consisting of: a vanadium redox couple (V³⁺/V²⁺), a quinone based redox couple, a phenazine-based derivative (DHPS (7,8-dihydroxyphenazine-2-sulfonic acid), DHPS/H₂-DHPS), a chromium redox couples (Cr³⁺/Cr²⁺), and an iron redox couple (Fe³⁺/Fe²⁺).

5. The system of claim 1, wherein the catalyst comprises an active catalyst material and a support material with a porous structure.

6. The system of claim 5, wherein the active catalyst material comprises molybdenum carbide, and the support material comprises alumina beads.

7. The system of claim 1, further comprising a container to store the protonated electrolyte for an extended period of time.

8. The system of claim 1, wherein the cathode comprises a material selected from the group consisting of: a carbon felt, a carbon cloth, a graphite felt, and a carbon felt coated with a gas diffusion layer.

9. The system of claim 1, wherein the anode comprises an iridium oxide coated titanium gas diffusion electrode.

10. The system of claim 1, further comprises an ion exchange membrane between the cathode and the anode, wherein the ion exchange membrane comprises a material selected from the group consisting of: Nafion®, Nafion® 212, Nafion® 211, and a Nafion® ionomer.

11. The system of claim 1, wherein the electrochemical cell is configured to achieve a current density greater than or equal to 200 mA/cm².

12. The system of claim 1, wherein the electrochemical cell is configured to operate at a voltage less than or equal to 2 V.

13. The system of claim 1, wherein the protonated electrolyte has a pH less than or equal to 2.

14. The system of claim 1, wherein the reactor comprises a material selected from the group consisting of: a nickel-chrome based alloy, a nickel-iron-chrome based alloys, an Inconel® alloy, Inconel® 625, an Incoloy® alloy, Incoloy® 20, a Hastelloy® alloy, and Hastelloy® C-276.

15. The system of claim 1, wherein the pressurized container is a gas liquid separator.

16. The system of claim 1, wherein the system is a batch reactor or a continuous reactor.

17. A method for generating gaseous hydrogen, comprising:
producing a protonated electrolyte in an electrochemical cell, wherein the electrochemical cell comprises:
a cathode that reduces a redox couple in an electrolyte, wherein the reduction reaction is not a hydrogen evolution reaction; and
an anode that oxidizes an oxygen evolution reaction to generate a plurality of protons to produce the protonated electrolyte;
contacting the protonated electrolyte with a catalyst in a reactor, wherein the catalyst catalyzes a reaction that oxidizes the reduced redox couple and reduces the plurality of protons to a gaseous hydrogen, and generate a discharged electrolyte; and
collecting a pressurized gaseous hydrogen by adding the discharged electrolyte and the gaseous hydrogen to a pressurized container, wherein the gaseous hydrogen separates from the discharged electrolyte such that the pressurized gaseous hydrogen is collected and the discharged electrolyte flows to the electrochemical cell;
wherein the pressurized gaseous hydrogen has a pressure of at least 700 bar.

18. The method of claim 17, further comprising pumping the protonated electrolyte into the reactor via a transfer cylinder, wherein the transfer cylinder comprises a moveable piston separating the transfer cylinder into a first chamber and a second chamber; wherein the second chamber receives the protonated electrolyte from the electrochemical cell; wherein a pump pressurizes an aqueous solution in the first chamber to move the piston towards the second chamber and pressurize the protonated electrolyte into the reactor, such that the pump is not in physical contact with the protonated electrolyte.

19. The method of claim 17, wherein the electrochemical cell has a configuration of a flow cell, a flow stack, or a flow assembly; wherein the pressurized container is a gas liquid separator.

20. The method of claim 17, wherein the redox couple dissolves in an aqueous solution and is selected from the group consisting of: a vanadium redox couples (V³⁺/V²⁺), a quinone based redox couple, a phenazine-based derivative (DHPS (7,8-dihydroxyphenazine-2-sulfonic acid), DHPS/H₂-DHPS), a chromium redox couples (Cr³⁺/Cr²⁺), and an iron redox couple (Fe³⁺/Fe²⁺); wherein the catalyst comprises an active catalyst material and a support material with a porous structure; wherein the reactor comprises a material selected from the group consisting of: a nickel-chrome based alloy, a nickel-iron-chrome based alloys, an Inconel® alloy, Inconel® 625, an Incoloy® alloy, Incoloy® 20, a Hastelloy® alloy, and Hastelloy® C-276; wherein the cathode comprises a material selected from the group consisting of: a carbon felt, a carbon cloth, a graphite felt, and a carbon felt coated with a gas diffusion layer; wherein the anode comprises an iridium oxide coated titanium gas diffusion electrode.
